(19) United States
(12) Patent Application Publication
(10) Pub. No.: US 2014/0164091 A1
(43) Pub. Date: Jun. 12, 2014

(54) Multi-Merchant Payment System Using Shopper Identifiers

(71) Applicant: Vince Hunt, Carmel, CA (US)

(72) Inventor: Vince Hunt, Carmel, CA (US)

(73) Assignee: SHOP MA, INC., Miami, FL (US)

(21) Appl. No.: 14/181,930

(22) Filed: Feb. 17, 2014

Related U.S. Application Data
(63) Continuation-in-part of application No. 12/727,627, filed on Mar. 19, 2010.

(51) Int. Cl. G06Q 30/02; G06Q 20/34

(52) U.S. Cl. CPC G06Q 30/0232; G06Q 20/342
USPC 705/14.32

(57) ABSTRACT

A device and method of electronic payment that enables an e-commerce server to maintain a database comprising records for shopper accounts, enable a shopper to interactively create a shopper account and to interactively deposit a specified amount of money in the shopper account, to provide the shopper with a unique shopper identifier that corresponds to the shopper account, to paying a merchant from the shopper account for a purchase at the merchant's e-commerce website by the shopper, where the shopper used the unique shopper identifier as a means of payment.

### REFERENCE TO RELATED APPLICATIONS

This application is a Continuation-In-Part of U.S. application Ser. No. 12/727,627, entitled Mufti-Merchant Reward Points Payment System, filed on Mar. 19, 2010 by inventor Vince Hunt, which is a Continuation-In-Part of U.S. application Ser. No. 13/236,349, entitled Mufti-Merchant Payment System, filed on Sep. 19, 2011, now U.S. Pat. No. 8,200,545 by inventor Vince Hunt, which is incorporated in its entirety by reference.

### FIELD OF THE INVENTION

The present invention relates to electronic on-line commerce.

### BACKGROUND OF THE INVENTION

E-commerce technology enables shoppers to purchase items of merchandise such as autos and clothes and items of service such as travel and insurance on-line, from websites that act as virtual stores. Pioneers of e-commerce include Amazon.com, Inc. of Seattle, Wash., eBay Inc. of San Jose, Calif., Expedia.com of Bellevue, Wash. and Market America of Greensboro, N.C. E-commerce technology combines on-line catalog ingest, browsing and search, inventory management, purchase and payment transactions, automated payment processing, and other components within a comprehensive e-commerce system.

The growth of the Internet as a medium for e-commerce has led to tremendous growth of product and service offerings. One example of this growth is the expansion from single merchant e-commerce websites that act as virtual stores, to multi-merchant e-commerce websites that act as virtual shopping malls. The multi-merchant e-commerce website provides a single integrated website where shoppers can purchase goods and services from a wide diversity of merchants. Multi-merchant e-commerce websites are able to incorporate features of single merchant websites, and have the potential of offering features beyond those offered on single merchant websites.

One increasingly popular feature of single merchant websites, which has proven to be a substantial source of revenue, is the commerce of online gift giving. One component of a gift giving system is a gift card. A gift giving system enables a gift giver to purchase a gift card for a specified amount of money at a merchant's website. The gift card is physically or electronically delivered to a recipient, referred to as a “gift card recipient,” designated by the gift giver. The gift card recipient can redeem the gift card for items of merchandise and/or services at the merchant's website. Typically, if his/her purchase amount is greater than the specified amount of the gift card, the gift card recipient pays the difference. If the purchase amount is less than the specified amount of the gift card, a balance remains on the gift card that can be used in the future.

Gift cards are typically based on a “closed loop” payment system in which the gift card recipient can only use or “redeem” the gift card at a single merchant's e-commerce website or store. In contrast, a credit card payment system constitutes an “open loop” payment system because a credit card can be used with many merchants, i.e. their use is not restricted to a single merchant or to a small number of merchants.

One drawback of a closed-loop gift card payment system is that a gift card recipient is limited to making product selections from a single merchant's e-commerce website and may not find sufficient items of interest. In this case a gift card may not be redeemed, or may be only partially redeemed, and yet the gift card giver was billed in full.

Implementing closed loop gift card payment systems on multi-merchant websites presents difficulties because each merchant requires a credit card or other form of payment. Thus, prior art multi-merchant payment systems required the gift card recipient to provide their own credit card at the time of purchase in order to pay the merchant whose merchandise and/or services the gift card recipient selected. For example, SHOP.COM, a multi-merchant e-commerce website, previously provided a gift card that required the gift card recipient to present a credit card with each purchase and the amount debited would later be credited or rebated to his/her credit card. This approach proved to not be attractive to shoppers.

Therefore it would be advantageous for a multi-merchant website to provide a payment system which acts as an open-loop payment system with respect to the gift card recipient allowing him/her to redeem the gift card from a large selection of merchants.

It would further be advantageous if the payment system would work with a large selection of single merchant websites in addition to the multi-merchant website and could be administered by the gift card recipient at the multi-merchant website, thus giving the gift card recipient an added reason to return to the multi-merchant website.

It would further be advantageous if a shopper at a multi-merchant website could create, fund and manage their own shopper account that could be used both at the multi-merchant website and at a large selection of single merchant websites.

Reward points programs, or loyalty programs, in which a consumer earns points for making purchases from or using the services provided by the company offering the reward points program, and can redeem these point for products or services at the company, are an example of a closed-loop payment system offered by many companies, including airlines, hotels and bookstores. Reward points programs are typically closed loop since the reward points can only be redeemed with the company offering the program. In contrast, the present invention enables a gift card giver to use reward points to purchase a gift card, thereby allowing a gift card recipient to select items of merchandise and/or services from a plurality of merchants. This effectively converts reward points programs into open-loop payment systems.

### SUMMARY OF THE DESCRIPTION

The present invention concerns e-commerce including the purchase of products such as clothing, books, electronic equipment and vehicles, and services such as travel and insurance, and more specifically to multi-merchant on-line shopping websites. Aspects of the present invention provide methods for multi-merchant payment, which enable a gift card giver to purchase a gift card that can be redeemed by a gift card recipient for a plurality of items of merchandise and services from a plurality of merchants.

The present invention accepts payment from a gift card giver and establishes a temporary, or virtual credit card (VCC) account that is then used to pay each merchant for purchases made by a gift card recipient. A gift card is then created and sent to a gift card recipient. The gift card includes a unique gift card code that acts as a proxy for the virtual credit card by referencing the virtual credit card account. The gift card recipient redeems the gift card by selecting items of merchandise and/or services at a multi-merchant e-commerce website and providing the gift card code as a means of payment. A multi-merchant e-commerce server which provides the multi-merchant e-commerce website then aggregates the selected items according to merchant and issues orders to each merchant according to the aggregated selected items. The e-commerce server uses the gift card code to obtain the virtual credit card account information and it includes the virtual credit card account information with the order. The merchant uses the virtual credit card information to obtain payment and ships the selected items to the recipient(s) designated in the order. It may be appreciated that from the perspective of the merchant the virtual credit card is indistinguishable from an ordinary credit card, i.e. the merchant processes the virtual credit card in the same way as an ordinary credit card.

In addition, the present invention concerns a payment system that enables a consumer, henceforth referred to as a “shopper,” to pay for items of merchandise and service at merchant websites using funds deposited in a shopper account.

In one embodiment, the invention concerns a device and method performed by a network computing device of payment for mufti-vendor gift cards that enables a gift card giver to interactively purchase a gift card for a specified amount of money for a gift card recipient and to provide method of payment information, to electronically obtain the specified amount of money using the method of payment information and to transfer the specified amount of money into a card funding account that is used to pay for purchases by the gift card recipient, to enable the gift card recipient to interactively select an item from the database; and to pay the merchant that corresponds to the selected item for the selected item from the card funding account.

In yet another embodiment, the invention concerns a method performed by a network computing device that enables a shopper to interactively create a shopper account and to interactively deposit a specified amount of money in the shopper account, to provide the shopper with a unique shopper identifier that corresponds to the shopper account, the unique shopper identifier serving as a means of payment for the shopper to make purchases at a plurality of merchants' e-commerce website and to pay a merchant from the shopper account for a purchase at the merchant's e-commerce website by the shopper, wherein the shopper used the unique shopper identifier as a means of payment.

### BRIEF DESCRIPTION OF THE DRAWINGS

The present invention will be more fully understood and appreciated from the following detailed description, taken in conjunction with the drawings in which:

FIG. 1 is a simplified block diagram of a multi-merchant reward points payment system that enables a shopper to select items from a multi-merchant website and to pay for the items using reward points from a reward program, in accordance with an embodiment of the present invention;

FIG. 2A is an example shopper interface that enables a shopper to browse for merchandise and services from a multi-merchant website, in accordance with an embodiment of the present invention;

FIG. 2B is an example shopper interface that enables a shopper to pay for his/her selections using reward points and to provide shipping, payment and billing information for his/her order, in accordance with an embodiment of the present invention;

FIG. 3A is a simplified diagram of an overall method performed by a multi-merchant reward points payment system, in accordance with an embodiment of the present invention;

FIG. 3B, a continuation of FIG. 3A, is a simplified diagram of the overall method performed by a multi-merchant reward points payment system, in accordance with an embodiment of the present invention.

FIG. 4 is a simplified diagram of a method for returning an item obtained from a multi-merchant reward points payment system, in accordance with an embodiment of the present invention;

FIG. 5 is a simplified block diagram of a multi-merchant reward points payment system that enables shoppers to purchase items using reward points and/or credit cards and for an e-commerce server to issue orders to merchants using credit cards, in accordance with an embodiment of the present invention;

FIG. 6 is a simplified block diagram that describes the functions performed by an e-commerce server that supports a multi-merchant reward points payment system, in accordance with an embodiment of the present invention;

FIG. 7 is a simplified block diagram of various components of the e-commerce server illustrated in FIG. 6, in accordance with an embodiment of the present invention;

FIG. 8 is a simplified block diagram of an example client-server architecture for implementing a multi-merchant reward points payment system, in accordance with an embodiment of the present invention;

FIG. 9 is simplified block diagram of a multi-merchant payment system that enables a gift card giver to purchase a gift card and for a gift card recipient to redeem the gift card by selecting items from a multi-merchant website, in accordance with an embodiment of the present invention;

FIG. 10A is an example user interface that enables a gift card giver to purchase a gift card, in accordance with an embodiment of the present invention;

FIG. 10B is an example user interface that enables a gift card recipient to redeem a gift card and to provide shipping, payment and billing information for his/her order, in accordance with an embodiment of the present invention;

FIG. 11A is a simplified diagram of an overall method performed by a multi-merchant payment system, in accordance with an embodiment of the present invention;

FIG. 11B, a continuation of FIG. 1A, is a simplified diagram of the overall method performed by a multi-merchant payment system, in accordance with an embodiment of the present invention.

FIG. 12 is a simplified block diagram of a multi-merchant credit card payment system that enables gift card givers to purchase gift cards using credit cards and for an e-commerce server to issue order to merchants using credit cards, in accordance with an embodiment of the present invention;

FIG. 13A is a simplified diagram of a method for issuing a gift card when the gift card is purchased using a credit card, in accordance with an embodiment of the present invention;

FIG. 13B is a simplified diagram of a method for redeeming a gift card using a virtual credit card account established by a multi-merchant e-commerce system, in accordance with an embodiment of the present invention;

FIG. 14 is a simplified block diagram that describes the functions performed by an e-commerce server that supports a multi-merchant payment system, in accordance with an embodiment of the present invention;

FIG. 15 is a simplified block diagram of various components of the e-commerce server illustrated in FIG. 14, in accordance with an embodiment of the present invention;

FIG. 16 is a simplified block diagram of an example client-server architecture for implementing a multi-merchant payment system, in accordance with an embodiment of the present invention;

FIG. 17 is a simplified block diagram that, relative to FIG. 9, adds the ability for a shopper to create and add funds to a shopper account that he/she can use to make selections, in accordance with an embodiment of the present invention; and

FIG. 18 is a simplified block diagram that, relative to FIG. 9, adds the ability for a gift card recipient to redeem his/her gift card at e-commerce websites provided by a plurality of merchants, in accordance with an embodiment of the present invention.

### DETAILED DESCRIPTION

Aspects of the present invention concern inter alia a multi-merchant reward points payment system, which enables a shopper to use reward points to purchase items of merchandise and/or service.

As used herein the following terms have the meaning given below:

Shopper—means an individual using a personal computer or mobile device to shop online, i.e. from an ecommerce website. A shopper uses a Web browser such as Mozilla Firefox or Microsoft Internet Explorer running on a client computer or a mobile device that provide Web access to websites including e-commerce websites. Examples of mobile devices that provide Web access include the APPLE IPHONE provided by Apple Computer of Cupertino Calif., and the BLACKBERRY provided by Research in Motion of Waterloo, Ontario. Unless otherwise specified, the term shopper as used herein refers to both the individual and their client computer or mobile device, i.e. the shopper's client computer or mobile device is not referred to separately.

Recipient—means an individual or individuals, company or organization that receives items of merchandise and/or service purchased using a multi-merchant reward points payment system.

Reward program—means a program offered by a reward program manager that enables shoppers to accumulate reward points and enables shoppers to redeem their reward points for items of merchandise and/or service.

Reward program manager—means a company that offers and manages a reward program.

Reward points—reward points are awarded to a shopper by a reward program when they use their reward program account in conjunction with a qualifying purchase.

Reward program account—means an account managed by a reward program manager for a shopper in which the shopper can accumulate reward points and redeem reward points for items of merchandise and/or service.

Item—means an item of merchandise such as an auto or a book or an item of service such as insurance for a motorcycle.

Multi-merchant website—means a single website that enables a shopper to inter alia search for, browse, select, and purchase items from a plurality of merchants. A multi-merchant website functions as an online shopping mall.

Merchant—means an individual or company that offers items for sale from a website. In the context of the present invention, a merchant may participate in a multi-merchant reward points payment system either directly or by being part of a multi-merchant website that itself uses a multi-merchant reward points payment system. Further, in the present invention, said merchants are the “merchants of record” for e-commerce credit card transactions, meaning that merchants charge shoppers' credit cards, or virtual credit cards (VCCs), directly.

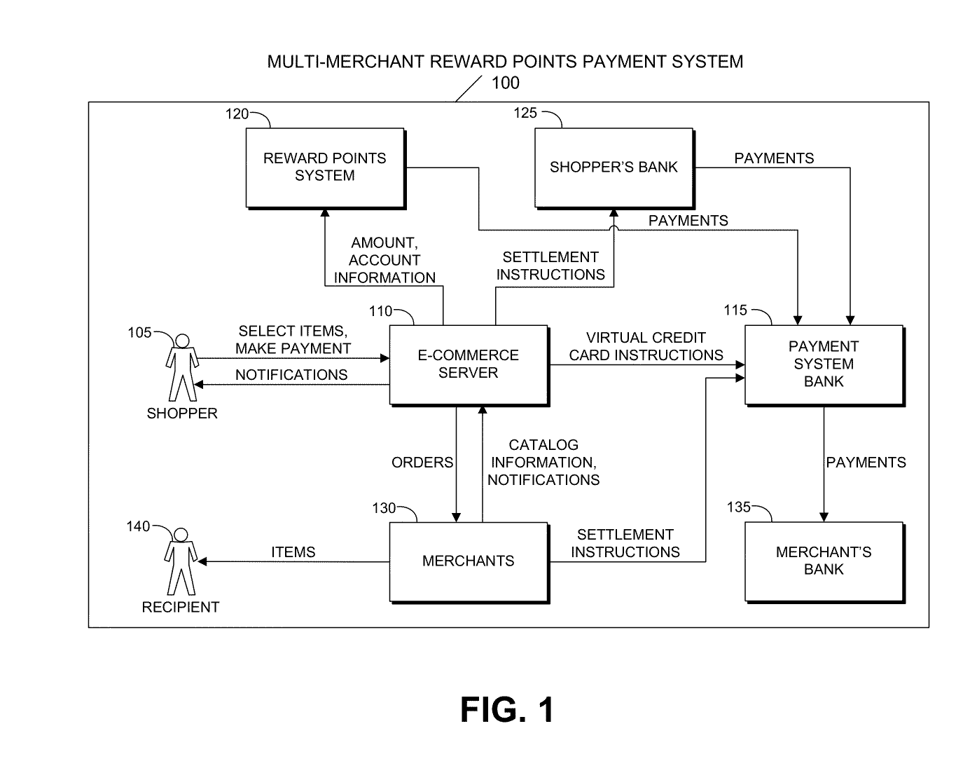

Reference is now made to FIG. 1, which is a simplified block diagram of a multi-merchant reward points payment system that enables a shopper to select items from a multi-merchant website and to pay for the items using reward points from a reward program, in accordance with an embodiment of the present invention. Shown in FIG. 1 is an e-commerce server 110 which interacts with at least one shopper 105, at least one payment system bank 115, at least one reward points system 920, a plurality of merchants 130, and at least one shopper's bank 125.

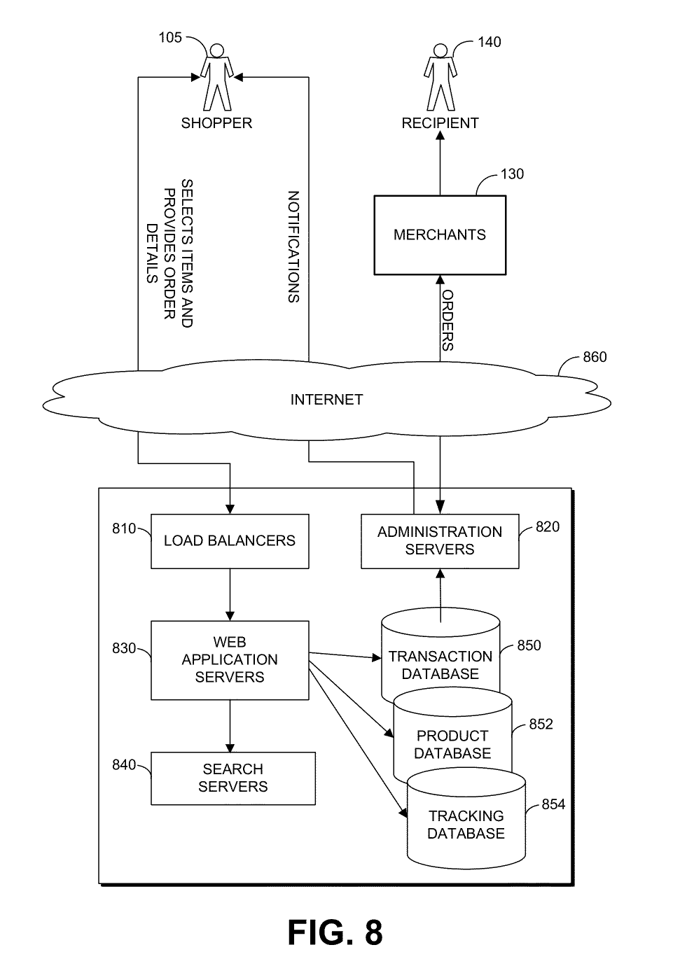

E-commerce server 110 is a server computer system that enables merchants 130 to publish and showcase their catalogs of merchandise and services on a multi-merchant website. E-commerce server 110 is represented as a single computer in FIG. 1 for the sake of clarity. However, e-commerce server 110 may be embodied in a single computer, or distributed as multiple computers communicating with one another. In the embodiment shown in FIG. 8, for example, e-commerce server 110 includes multiple Web application servers, administration servers, search servers, and load balancers.

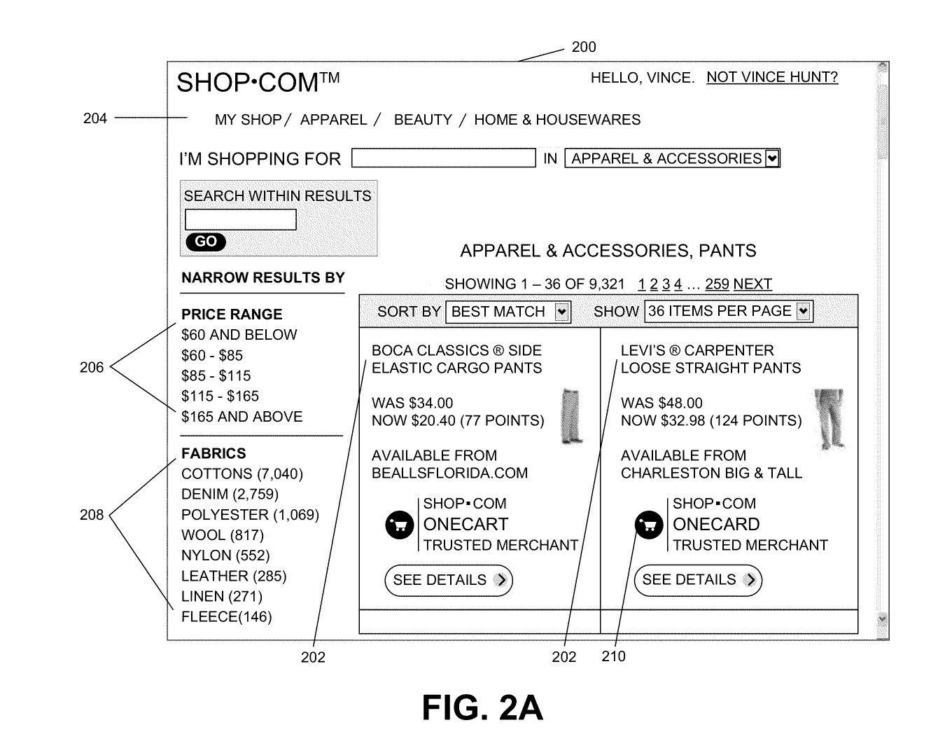

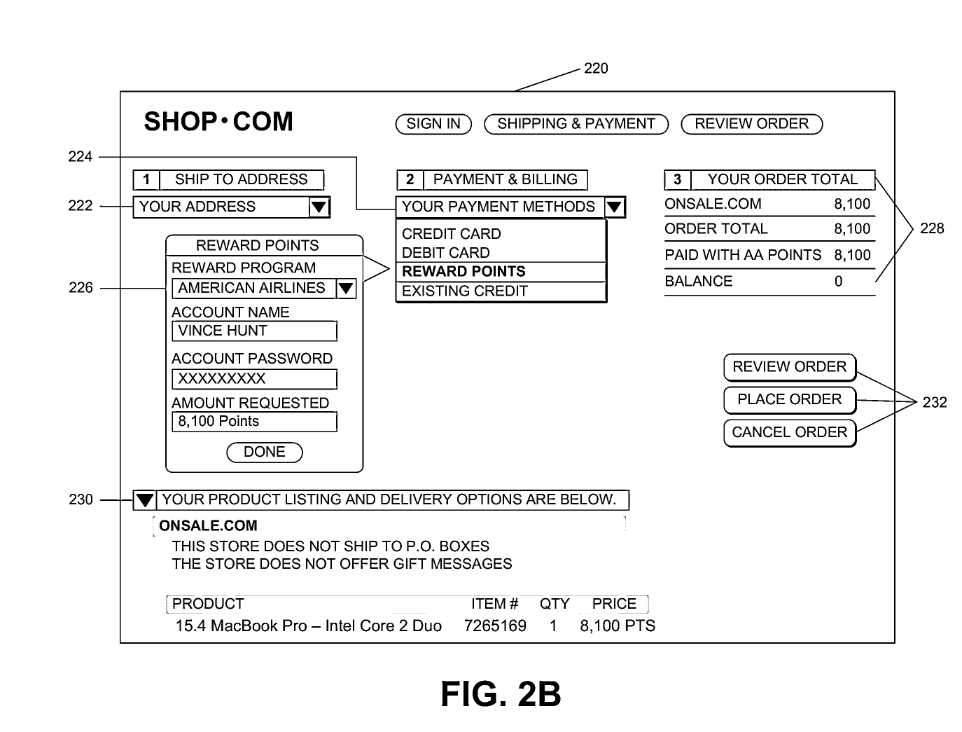

In accordance with an embodiment of the present invention, shopper 105 visits the multi-merchant website provided by e-commerce server 110 and shops, i.e. selects one or more items. An example of a user interface that e-commerce server 110 might provide to enable shopper 105 to shop is described with reference to FIG. 2A. Said items are provided by merchants 130 that participate in the multi-merchant website by providing catalog information about their items to e-commerce server 110. Generally, shopper 105 registers with e-commerce server 110 by providing basic information including inter alia name, physical address, e-mail address, method of payment information, shipping information, and personal information that may be used for authenticating the shopper.

After selecting one or more items, shopper 105 finalizes his/her order by checking out. During the checkout process, shopper 105 provides shipping and payment information and may review the order details. When providing payment information, shopper 105 specifies his/her preferred method of payment which includes reward points from a reward program account, credit card and debit card. An example shopper interface that enables shopper 105 to provide shipping, payment and billing information is described with respect to FIG. 2B.

If shopper 105 selects a reward points payment method, then e-commerce server 110 uses the supplied reward program account information to obtain payment from reward points system 120 operated by its reward program manager. Typically, reward points system 120 provides a real-time Web interface that enables e-commerce server 110 to request that reward points system 120 redeem reward points accumulated by shopper 105 and held in his/her reward program account. In one embodiment, the Web interface provided by reward points system 120 uses a a remote procedure call (RPC) mechanism such as that provided by Web service as defined by the World Wide Web Consortium (W3C). In this embodiment, e-commerce server 110 requests redemption by electronically transmitting a redemption request message to reward points system 120. Then, reward points system 120 performs the redemption operation and responds to the redemption request by sending a redemption response message to e-commerce server 110. The redemption request message includes information about the reward program account to be used and the number of points requested. The redemption response message provides the status of the redemption operation. Further information about Web services can be found at http://www.w3.org/.

To perform the redemption operation, reward points system 120 debits the shopper's reward account the requested number of reward points. The reward points are then converted to a payment amount using a conversion or exchange rate that has been previously agreed to by the reward program manager and the operator of the reward points payment system. Then, reward points system 120 electronically transfers said payment amount into a “card funding account” specified in the redemption request message. The card funding account, located in payment system bank 115, is used to pay merchants 130 for orders placed by shopper 105.

Shopper 105 may use multiple payment methods to pay for an order. For example, shopper 105 may pay for one part of an order using reward points and the remaining part using a credit card. Also, it may occur that the reward program account for shopper 105 does not contain sufficient reward points to pay for the full order. In this case, e-commerce server 110 prompts shopper 105 to pay the balance of the order, i.e the portion not covered by his/her reward points using an additional payment method. Shopper 105 may select another reward program account as the method of payment for the balance. Alternatively, shopper 105 may select a credit card as the method of payment for the balance. In this case, e-commerce server 110 sends credit card settlement instructions to a shopper's bank 125. Shopper's bank 125 then makes the requested payment into the card funding account for shopper 105 located in payment system bank 115. It may be appreciated by one skilled in the art that payment methods in addition to reward points and credit card including inter alia debit card and electronic funds transfer systems such as PAYPAL may be provided by reward points payment system 100. PAYPAL is an online payment system owned and operated by eBay, Inc. of San Jose, Calif.

When payment system bank 115 first receives a payment into the card funding account for shopper 105, e-commerce server 110 establishes and loads a “virtual credit card account” for shopper 105 with the amount deposited. It may be appreciated that such payment may be a funds transfer from reward points system 120 as a result of shopper 105 choosing reward points as the method of payment; or it may be the result of shopper 105 choosing a different method of payment such as credit card. If a virtual credit card account for shopper 105 already exists, e-commerce server 110 reloads the account with the amount of the deposit. The virtual credit card account acts like a standard credit card account in that it is established, funded, has a unique credit card number, and is guaranteed and operated by a bank. The amount credited to the virtual credit card acts a limit against which purchases can be made and fees may be assessed. The act of establishing an initial amount is referred to as “loading” the virtual credit card account. The act of adding additional funds to the account is referred to as “reloading” the virtual credit card account. The key differences between a virtual credit card and a standard credit card are that (1) it is managed by e-commerce server 110 and not by shopper 105, (2) it is terminated when the balance is used up, i.e. it is temporary in nature, and (3) no physical credit card is ever issued. Establishing and loading a virtual credit card are two of the virtual credit card instructions that e-commerce server 110 may issue to payment system bank 115. Other instructions include reloading and closing a virtual credit card account.

The actual credit card number is stored and managed by e-commerce server 110. E-commerce server 105 provides the credit card number to merchants 130 to pay for purchases made by shopper 105 on the multi-merchant website.

In one embodiment, e-commerce server 110 generates a proxy number that it presents to shopper 105. In this embodiment, shopper 105 may use the proxy number on websites that participate in reward points payment system 100. Such websites, in turn, supply the proxy number to e-commerce server 110 and in return obtain the virtual credit card number that they use to obtain payment for purchases made by shopper 105.

In another embodiment, e-commerce server 110 provides the actual credit card number to shopper 105 to use for making purchases. Such purchases are unrestricted since the credit card number is fully operational, albeit with a limited amount of funds to draw on, i.e. the amount of funds in the card funding account.

When the checkout process is complete, e-commerce server 110 aggregates the selected items according to merchant and issues orders to each merchant 130 according to the aggregated selected items. E-commerce server 110 includes the virtual credit card account information with the order.

Merchant 130 uses the virtual credit card information to request authorization and settlement for their portion of the order from payment system bank 115. Payment system bank 115 authorizes and settles the credit card transaction and payment is made to a designated account in a merchant's bank 935. Each merchant 130 ships the selected items to each item recipient 140, also referred to as recipient 140, as indicated in the order. Shopper 105 may be a recipient of an item shipped by merchant 130, but in fact an item may be shipped to anyone. Recipient 140 does not have to be a registered shopper.

Reference is now made to FIG. 2A which is an example shopper interface that enables a shopper to browse for merchandise and services from a multi-merchant website, in accordance with an embodiment of the present invention. Typically, shopper 105 begins browsing from a home page, which is a web page that displays a list of categories of merchandise and services. On the home page, shopper 105 may inter alia select a category from the list of categories or search entering keywords into a search box. Shopper interface 200 appears after shopper 105 selects “Apparel and Accessories” from the home page and then selects the subcategory “Men's Pants.” Two products 202 are visible in shopper interface 200: a “BOCA CLASSICS SIDE ELASTIC CARGO PANTS”, and a “LEVI CARPENTER LOOSE STRAIGHT PANTS”. Each product is supplied by a different merchant 130, e.g. BOCA CLASSICS CARGO PANTS are available from BeallsFlorida.com and LEVI CARPENTER LOOSE STRAIGHT PANTS are available from Charleston Big & Tall. The price of each product is displayed in both dollars ($) and reward points. Shopper 105 may click on the photo or product name to obtain additional information about the product. Shopper 105 may inter alia click on a different top level menu category 204 which includes “my shop”, “apparel”, “beauty”, “home & housewares”, or select a price range 206, or a fabric 208. At any time shopper 105 may click on a shopping cart control 210 which adds the item to his/her shopping card and navigates to the shopping card where shopper 105 may inter alia change the quantity of an item, delete an item, or proceed with check out.

Reference is now made to FIG. 2B which is an example shopper interface that enables a shopper to pay for his/her selections using reward points and to provide shipping, payment and billing information for his/her order, in accordance with an embodiment of the present invention. Typically, every web page provided by the multi-merchant website includes a navigation control that enables shopper 105 to visit his/her shopping cart. Several of the capabilities provided by a shopping cart are shown in example shopper interface 220. Shopper 105 may select a ship to address from a menu of ship to addresses 222 that he/she has previously supplied. Alternatively, shopper 105 may add a new ship to address. Shopper 105 may select a payment method using a payment method menu 224. If shopper 105 selects “Reward Points” as the payment method then a reward points dialog box 226 appears that enables shopper 105 to select a reward program account that he/she wishes to use to pay for the items he/she has added to the shopping cart. Shopper 105 is further prompted in reward points dialog box 226 to provide his/her reward program account name and reward program account password. The amount of the order, in reward points, appears in an amount requested field within reward points dialog box 226. Shopper 105 may change the amount requested. If he/she changes the amount requested to be less than the order total then he/she must subsequently provide another method of payment to pay the remaining balance. If he/she requests an amount greater than the order total then his/her account will be credited with the difference.

The items in the shopping cart are shown in an order total box 228 aggregated by merchant. A product listing section 230 lists the items selected aggregated by merchant together with any special information for the merchant including inter alia shipping and delivery options. A set of controls 232 enables shopper 105 to review the order, place the order, or cancel the order.

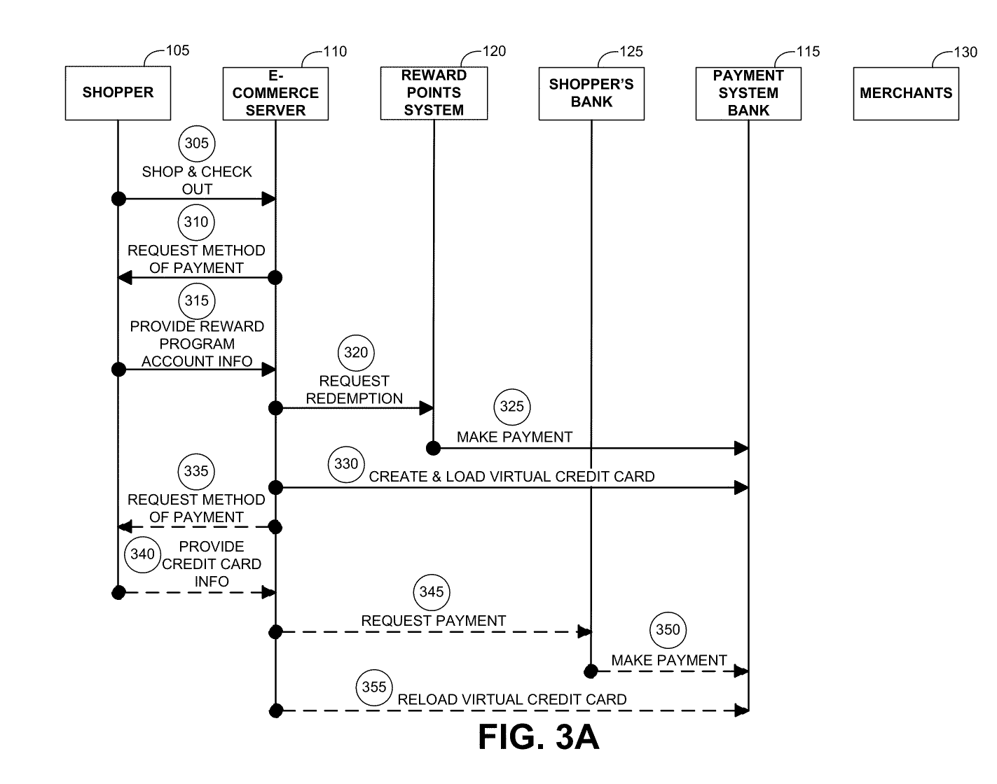

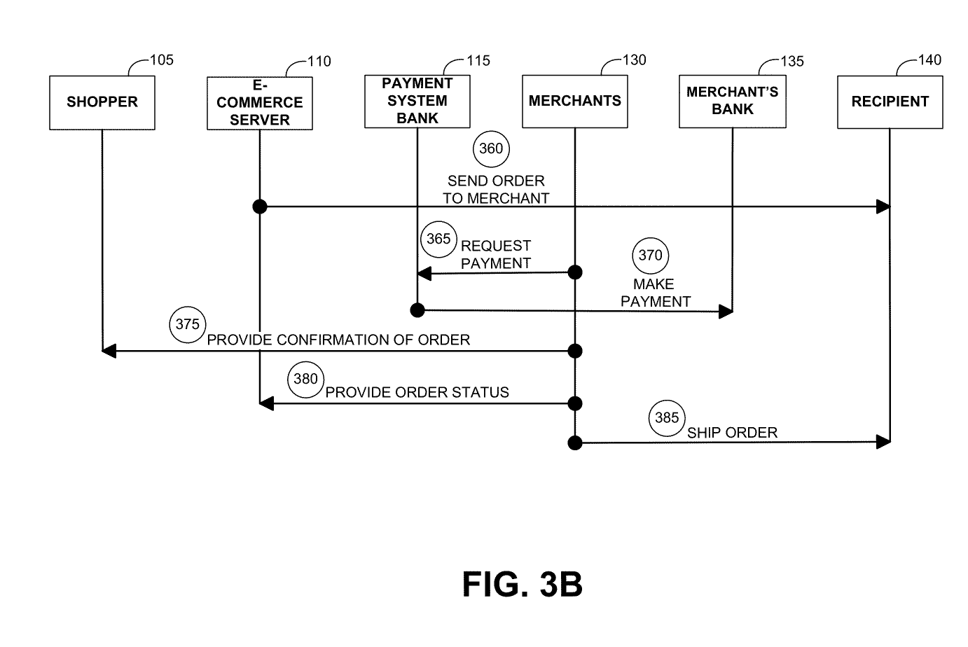

Reference is now made to FIG. 3A which is a simplified diagram of an overall method performed by a multi-merchant reward points payment system, in accordance with an embodiment of the present invention. At step 305 shopper 105 shops for items of merchandise and/or service at the multi-merchant ecommerce website and selects the checkout function. In one embodiment, if shopper 105 is not yet a registered shopper he/she is required to register and establish an account with e-commerce server 110 at this point.

At step 310 e-commerce server 110 prompts shopper 105 to provide information including method of payment. At step 315 shopper 105 selects “REWARD POINTS” as his/her method of payment, provides the requested reward program account information and indicates the number of points requested. At step 320 e-commerce server sends a redemption request message to reward points system 120 to redeem the number of reward points requested at step 315. At step 325 reward points system 120 makes a payment by electronically transferring the requested amount, based on the agreed to reward points to currency exchange rate, to the card funding account for shopper 105 in payment system bank 115.

At step 330 e-commerce server 110 issues instructions to payment system bank 115 to create a virtual credit card account and load it with the amount just paid by reward points system 120. In this step, e-commerce server 110 stores the virtual credit card account information into a shopper record for shopper 105. The shopper record is a database record that stores information concerning shopper 105.

Steps 335-355 are only performed if the payment made by reward points system 120 is less than the amount of the order. This may happen if there are insufficient reward points in the reward program account of shopper 105 to cover the full amount of the order or if shopper 105 requested a number of points at step 315 that is less than the number of points required to pay for the entire order. At Step 335 shopper 105 is informed that the amount of money paid by reward points system 120 at step 325 is insufficient to cover the order and is prompted to select a supplemental method of payment to pay the remaining amount. In one embodiment, shopper 105 may select any method of payment that has not previously failed to generate the full amount of money or points requested. For example, shopper 105 may select a credit card, different reward program, or PAYPAL as a supplemental method of payment.

At step 340, shopper 105 selects credit card as the method of payment and provides the necessary credit card information including the name of the account holder, account number and amount. Then, at step 345 e-commerce server 110 requests payment by shopper's bank 125 into the previously established card funding account for shopper 105 residing in payment system bank 115. For purposes of clarification, shopper's bank 125 is the issuing bank for the credit card provided by shopper 105 for the transaction.

At step 350 shopper's bank makes a payment of the requested amount which results in a deposit into the card funding account in payment system bank 115 for shopper 105. Next, at step 355 e-commerce server 110 reloads, or adds to, the virtual credit card account the amount deposited into the card funding account.

Reference is now made to FIG. 3B, a continuation of FIG. 3A, which is a simplified diagram of an overall method performed by a multi-merchant reward points payment system, in accordance with an embodiment of the present invention. At step 360 e-commerce server 110 aggregates the selected items according to merchant and sends orders to each merchant 130 from which an item has been ordered. E-commerce server 110 sends the virtual credit card information with each order.

At step 365 merchant 130 issues a request for payment for the order from payment system bank 115 which is the issuing bank for the virtual credit card. At step 370 payment system bank 115 makes a payment to a designated account in merchant's bank 135. At step 375 merchant 130 provides confirmation of the order to shopper 105. At step 380 merchant 130 provides the status of the order to e-commerce server 110. Finally, at step 385, merchant 130 ships the item(s) specified in the order to recipient 140. It should be noted that there may be more than one recipient 140. Depending on the number of recipients, the size of the items to be shipped, and the availability and the physical location of the items, merchant 130 may be required to perform more than one shipment.

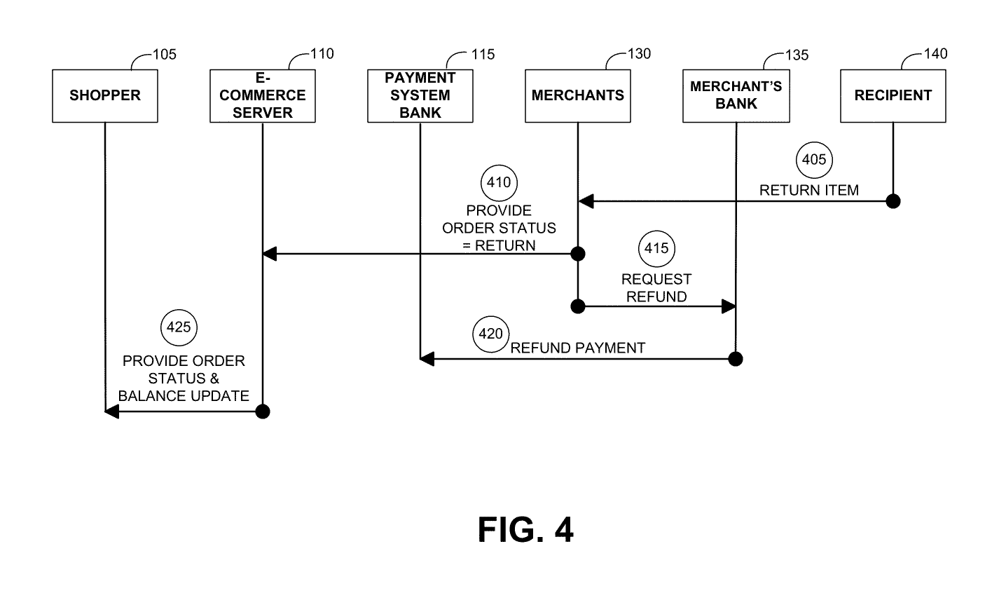

Reference is now made to FIG. 4 which is a simplified diagram of a method for returning an item obtained from a multi-merchant reward points payment system, in accordance with an embodiment of the present invention. This method concerns the return of an item ordered by shopper 105 and shipped to a recipient 140. As previously discussed, recipient 140 may be any individual, regardless of whether said individual is a registered shopper. Further recipient 140 may be the same individual as shopper 105 in the event that shopper 105 purchases an item for themself and wishes to return it. At step 405 recipient 140 returns the item to merchant 130. In one embodiment, to perform the return recipient 140 calls or emails merchant 130 prior to actually shipping back the item. In turn, merchant 130 provides a return merchandise authorization (RMA) number together with shipping instructions. Recipient 140 then re-packages and ship the item to merchant 130, providing said RMA number on or inside the package.

At step 410 merchant 130 provides e-commerce server 110 an updated order status indicating that the item has been returned. Then, at step 415 merchant 130 issues a request to merchant's bank 135 to refund the amount that was paid to merchant 130 for the received items. At step 420 merchant's bank 135 repays the amount of the item returned to the card funding account in payment system bank 115. Merchant's bank 135 uses the virtual credit card that was supplied with the order to perform the refund. As previously discussed, the virtual credit card behaves like a standard credit card, thus returning is a standard credit card operation. In one embodiment, merchant 130 may reduce the credited amount by inter alia a restocking or shipping fee.

Finally, at step 425, e-commerce server 110 updates the shopper record to reflect the new balance in the virtual credit card account and notifies shopper 105 of the status of the returned order indicating the new balance in his/her account. In this embodiment, any reward points used to pay for the order have been converted to funds and remain in the card funding account of shopper 105. In another embodiment, any reward points used to pay for the order can be restored to the reward program account of shopper 105.

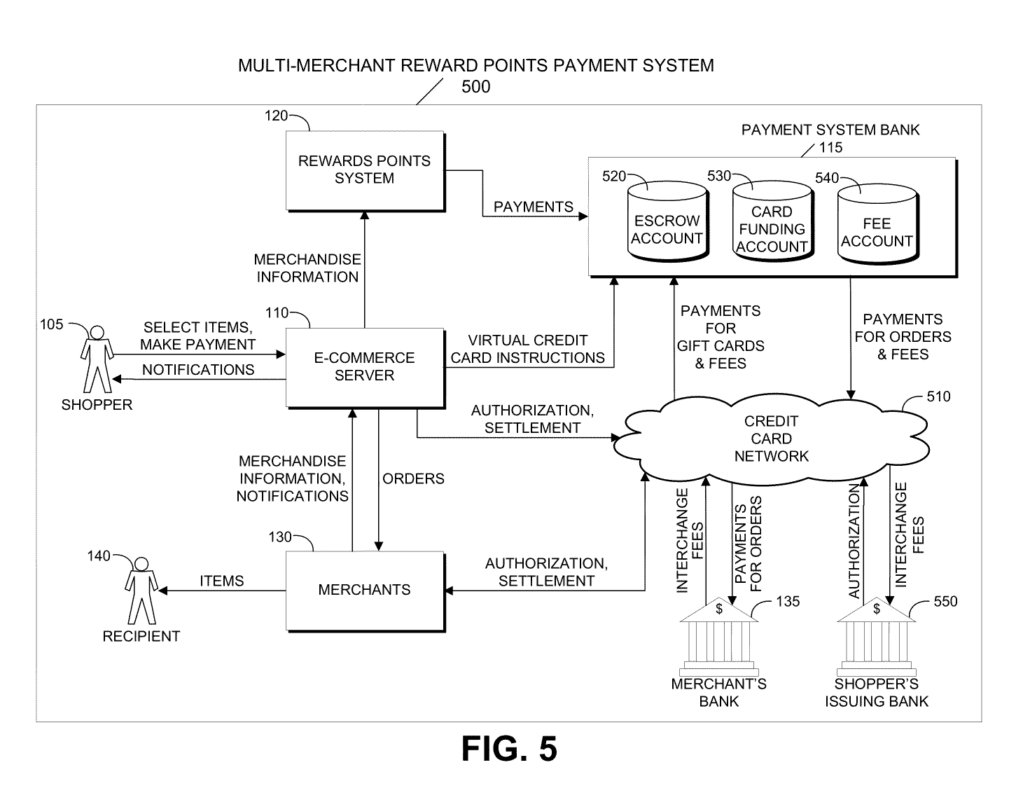

Reference is now made to FIG. 5 which is a simplified block diagram of a multi-merchant reward points payment system that enables shoppers to purchase items using reward points and/or credit cards and for an e-commerce server to issue orders to merchants using credit cards, in accordance with an embodiment of the present invention. FIG. 5 illustrates one embodiment of multi-merchant reward points payment system 100, described with reference to FIG. 1, in which payments to merchants are made using credit cards such as VISA, MASTERCARD, AMERICAN EXPRESS and DISCOVER. Such credit card transactions are carried out across a credit card network 510.

In the embodiment illustrated in FIG. 5, shopper 105 uses reward points as his/her means of payment for items he/she has selected from the multi-merchant e-commerce website provided by e-commerce server 110. Shopper 105 provides the requested reward program account information as discussed with reference to FIG. 2B.

E-commerce server 110 uses the reward program account information to request that reward points system 120 make a payment to a designated card funding account 530 in payment system bank 115. Reward points system 120 may make a direct electronic funds transfer into card funding account 530; alternatively, reward points system 120 may pay using a credit card. Additional mechanics of credit card payments are discussed below.

As previously described, after payment has been successfully processed, e-commerce server 110 issues instructions to payment system bank 115 to establish and load a virtual credit card account. It should be noted that payment system bank 115 is the issuing bank for the virtual credit card. Thus, any interchange fees collected by credit card network 510 for use of the virtual credit card will be paid to payment system bank 115. In one embodiment, payment system bank 115 shares interchange fees collected for use of virtual credit cards with the operator of multi-merchant payment system 500. Said shared interchange fees are paid into a designated fee account 540.

The virtual credit card account allows it to also act an “open-loop” payment method with respect to merchants 130 since the virtual credit card is used to pay a plurality of merchants 130.

It may be appreciated that e-commerce server 110 may work in conjunction with commercial services such as those provided by eFunds and Metavante to establish and manage a virtual credit card account. eFunds Corporation is based in Scottsdale, Ariz. Metavante Corporation is headquartered in Milwaukee, Wis., and is the principal subsidiary of Metavante Technologies, Inc.

As previously described, e-commerce server 110 issues an order to each merchant 130 from which shopper 105 selected an item. The order includes the virtual credit card information for the shopper 105 account managed by e-commerce server 110. As with any other credit card transaction, merchant 130 uses the virtual credit card information to request authorization and settlement from credit card network 510. Using credit card network 510, payment system bank 115 authorizes and settles the transaction, crediting the amount to a specified account in a merchant's bank 135. The amount credited is the amount of the items purchased minus an interchange fee. Credit card network 510 pays the interchange fee to payment system bank 115 which is the issuing bank for the virtual credit card that was used to pay merchant 130. By mutual agreement, payment system bank 115 pays a share of interchange fees that it collects for use of virtual credit cards into fee account 540.

For purposes of clarity, credit card network 510 includes a credit card processor for e-commerce server 110, a credit card processor for merchant 130 and a credit card network supported by each credit card processor. To further clarify, when a merchant receives an order from e-commerce server 110 and accepts a virtual credit card as payment for the order, the virtual credit card number, the amount, and an unique merchant identification code travel over their respective credit card processor's computer network. The credit card processor can either be a bank or a company that provides credit card processing services. From the processor's network the transaction goes to a credit card computer network. The electronic transaction travels across the network to the bank that actually issued the card, commonly referred to as the “issuing bank”. The issuing bank checks the account and verifies that there is adequate credit in the virtual credit card account to cover the purchase. The issuing bank then sends the merchant an authorization over the network. At this point, the sale is complete. Next, the transaction is “settled.” Settlement of a transaction occurs when the issuing bank for the virtual credit card debits the corresponding card funding account and makes appropriate payments. The merchant in turn credits the merchant's bank account for the transaction amount, minus its fees for the transaction. Those fees are allocated between the issuing bank and the credit card network itself.

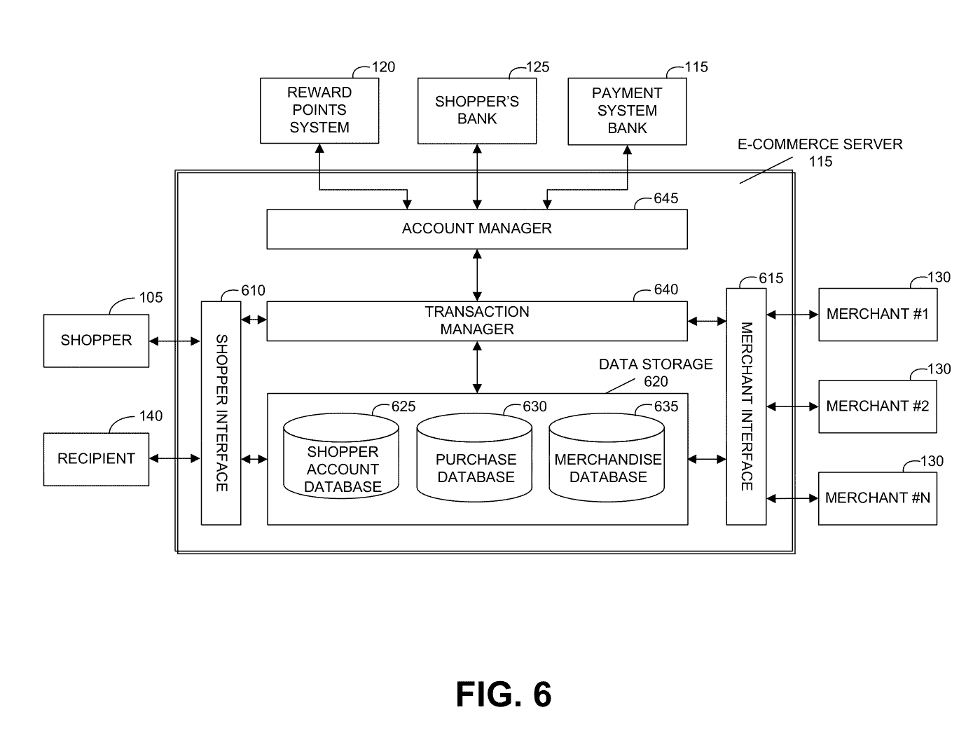

Reference is now made to FIG. 6, which is a simplified block diagram that describes the functions performed by an e-commerce server that supports a multi-merchant reward points payment system, in accordance with an embodiment of the present invention. Shoppers interact with the website via a shopper interface 610, merchants interact with the website via a merchant interface 615, and e-commerce server 110 interacts with reward points system 120, shopper's bank 125 and payment system bank 115 via an account manager 645.

A data storage 620 stores a shopper account database 625, a purchase database 630 and a merchandise database 635. Data storage 620 is a logical storage system typically implemented using a relational database manager; it may be implemented using a range of commercially available physical storage devices.

Shopper account database 625 stores a shopper record for each shopper 105. The shopper record maintains the shopper account information. Each record includes (i) a shopper name, (ii) a shopper identifier that uniquely identifies the shopper and the shopper account, (iii) billing and shipping address for the shopper, and (iv) means of payment information for each means of payment supplied by the shopper, including credit card information and reward program account information, (v) the balance of the shopper account, and (vi) virtual credit card information for the shopper account.

Purchase database 630 stores a purchase record for each order made by shopper 105. The purchase record includes includes (i) a unique identifier for the order, referred to as an order id, (i) a shopper identifier that uniquely identifies the shopper, (ii) the date and time of the order, (iii) means of payment information including any transaction information such as a credit card authorization number, (iv) the amount of the order, (v) the items ordered and the price of each, (vi) the name and contact information of each recipient, (viii) an optional message from shopper 105 to each recipient 140.

Merchandise database 635 stores a record for each item of merchandise or service published by any merchant 130. Each record includes (i) a stock keeping unit (SKU) for the item, (ii) a description of the item, (iii) a description of product options for the item, (iv) a price of the item with and without the product options, (v) shipping information for the item including shipping cost, and (vi) the merchant who provides the item. The SKU functions as a unique identifier for the item. The description generally includes one or more images of the item and a text description.

Merchandise database 635 also stores the agreed to conversion rates for each reward program. In one embodiment, there is a plurality of conversion rates for each reward account. For example, one rate may be applied for gold card reward members, another for platinum members and so forth. In another embodiment, the conversion rate is dynamic and is established at the time e-commerce server 110 initiates a redemption transaction.

Shopper interface 610 enables shopper 105 to browse and search merchandise database 635 for desired items of merchandise and service, and purchase desired items on-line. Shopper interface 610 is typically a web interface that provides HTML web pages. Said HTML web pages may be static web pages stored as HTML files or may be generated dynamically in response to shopper requests.

Merchant interface 615 enables merchants to add new items to merchandise database 635, remove old items of merchandise, and modify existing items. Merchant interface 615 enables merchants to view and print database reports about sales of their items of merchandise and service sold through e-commerce server 115.

After shopper 105 makes his/her selection of items, a transaction manager 640 enables shopper 105 to check out, i.e. provide information necessary to complete the order, and review details of the order. If shopper 105 is not a registered shopper, then transaction manager 640 prompts shopper 105 to register with e-commerce server 110. In this case, transaction manager 640 creates a new record in shopper account database 625 for the new shopper.

During checkout, transaction manager 640 enables shopper 105 to provide details about the order including billing, recipient and means of payment information. Transaction manager uses an account manager to request and obtain payment for the order using the means of payment information supplied by shopper 105. If the initial means of payment, e.g. a reward program account, does not pay for the full order then shopper 105 is requested by transaction manager 640 to provide a supplemental means of payment to pay the remaining amount due for the order. This process may continue until the full amount of the order has been received in card funding account 530. Alternatively, shopper 105 may delete one or more items he/she selected in order to reduce the purchase price.

After payment for the order has been received, transaction manager 640 stores a purchase record containing information about the order in purchase database 630. Thus, purchase database 630 stores a record for each order placed by shopper 105.

After payment for the order has been received, transaction manager 640 aggregates the selected items according to merchant 130. Transaction manager 640 then issues orders to each merchant 130 according to the aggregated selected items. Each order includes the virtual credit card information for shopper 105. As previously mentioned, from the perspective of merchant 130, a virtual credit card is the same as a standard credit card, i.e. merchant 130 processes a virtual credit card in the same way that they process a standard credit card. Each merchant 130 ships the selected items indicated in their order to the designated address(es).

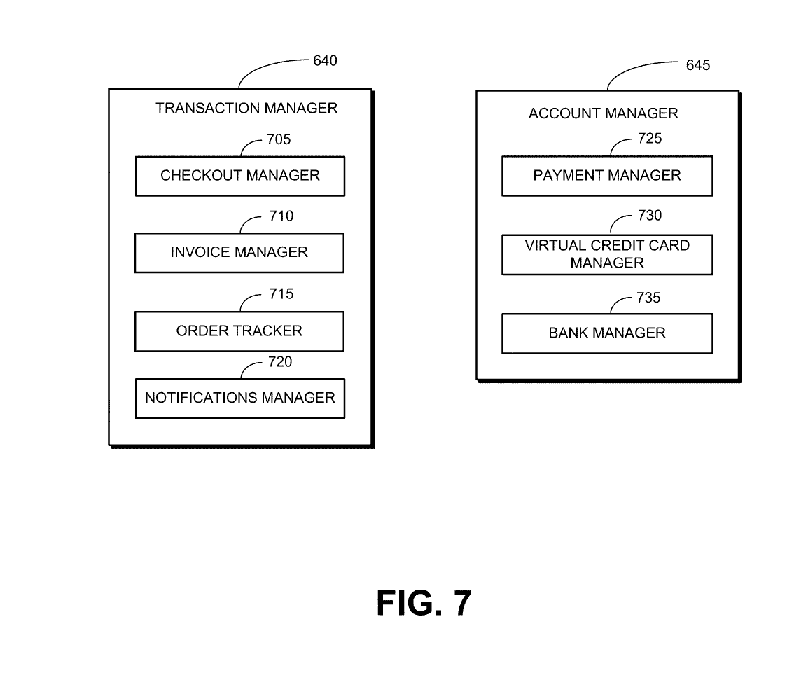

Transaction manager 640 provides shopper 105 with electronic notifications at specified points during a shopping transaction as will be discussed further with reference to FIG. 7.

Account manager 645 processes the means of payment information provided by shopper 105 on behalf of transaction manager 640. Account manager 645 uses the means of payment information to cause shopper payments to be made from reward points system 120 and shopper's bank 125 into the card funding account in payment system bank 115. Account manager 645 further manages the payment and receipt of transaction fees. Account manager 645 tracks payments into and out of the card funding account and any other accounts in payment system bank 115. For each shopper, account manager 645 manages a virtual credit card that is used to make payments to merchants by performing operations including creating, loading, reloading, and closing the virtual credit card. Account manager 645 stores the virtual credit card information with the shopper record in shopper account database 625.

Reference is now made to FIG. 7, which is a simplified block diagram of various components of the e-commerce server illustrated in FIG. 6, in accordance with an embodiment of the present invention. Shown in FIG. 7 are sub-components of transaction manager 640, and account manager 645.

Transaction manager 640 includes a checkout manager 705 for managing the checkout process including obtaining delivery information, payment and billing information. Transaction manager 640 further includes an invoice manager 710 for invoicing shopper 105 based upon his/her selected items, and an order tracker 715 for tracking the items ordered by shopper 105. Finally, transaction manager 640 includes a notifications manager 720 that notifies shopper 105 when inter alia payment has been received and the order is approved, when an item is not available from merchant and shipment will be delayed, when merchant 130 ships an order, and when recipient 140 returns an item and a refund is processed.

Account manager 645 includes a payment manager 725 that manages the process of obtaining payment from inter alia reward points system 120 and shopper's bank 125. Payment manager 725 is capable of redeeming points from a plurality of reward points systems and obtaining payment from credit card network 510 in the case that shopper 105 pays with a credit card. It may be appreciated that payment manager 725 may operate with a wide variety of electronic payment systems.

Account manager 645 further includes a virtual credit card manager 730 that creates a virtual credit card for each order made by shopper 105, unless a virtual credit card already exists for shopper 105. Virtual credit card manager 730 stores information about the order in purchase database 630. Virtual credit card manager 730 is capable of loading, reloading and closing a virtual credit card account.

Account manager 645 further includes a bank manager 735 that manages interactions with payment system bank 115. Bank manager 830 verifies the balances in each of the accounts used by e-commerce server 110 including the card funding account and fee account. Bank manager 735 ensures that all necessary fees are paid to and collected from credit card network 510.

It will be appreciated by those skilled in the art that the systems and methods of the present invention may be implemented within a variety of server-client network architectures. In this regard, reference is now made to FIG. 8, which is a simplified block diagram of an example client-server architecture for implementing a multi-merchant reward points payment system, in accordance with an embodiment of the present invention. On the server side, the architecture in FIG. 8 includes one or more Web application servers 810 managed by load balancers 820, administration servers 830, search servers 840, and three databases. The databases include a transaction database 850 for recording purchase and payment information, including the data from purchase database 630 shown in FIG. 6, a product database 852 for storing product catalog information, including the data from merchandise database 635, and a tracking database 854 for tracking shopper orders and shopper information including shopper account database 625. Web application servers 830 manage transaction database 850, product database 852, tracking database 854, and search servers 840. It may be appreciated by one skilled in the art that Web application servers 830 also act as Web servers in that they accept HTTP requests from Web browsers and serve them HTTP responses along with optional data contents, which usually are web pages such as HTML documents and linked objects (images, etc.). All of these server components are subsumed in e-commerce server computer 115.

On the client side, the architecture shown in FIG. 8 includes shopper 105 using a client computer, merchants 130, and recipient 140 using a client computer. Merchants 130 have two-way connections with administration servers 820. Administration servers 820 send notifications to shopper 105. Thus, the client computers of shopper 105 have one-way connections with administration servers 820. The client computers of shopper 105 have two-way connections with load balancers 810.

Client-server communication is performed over the Internet 860 or other private and/or public communication networks.

### Gift Card Embodiments

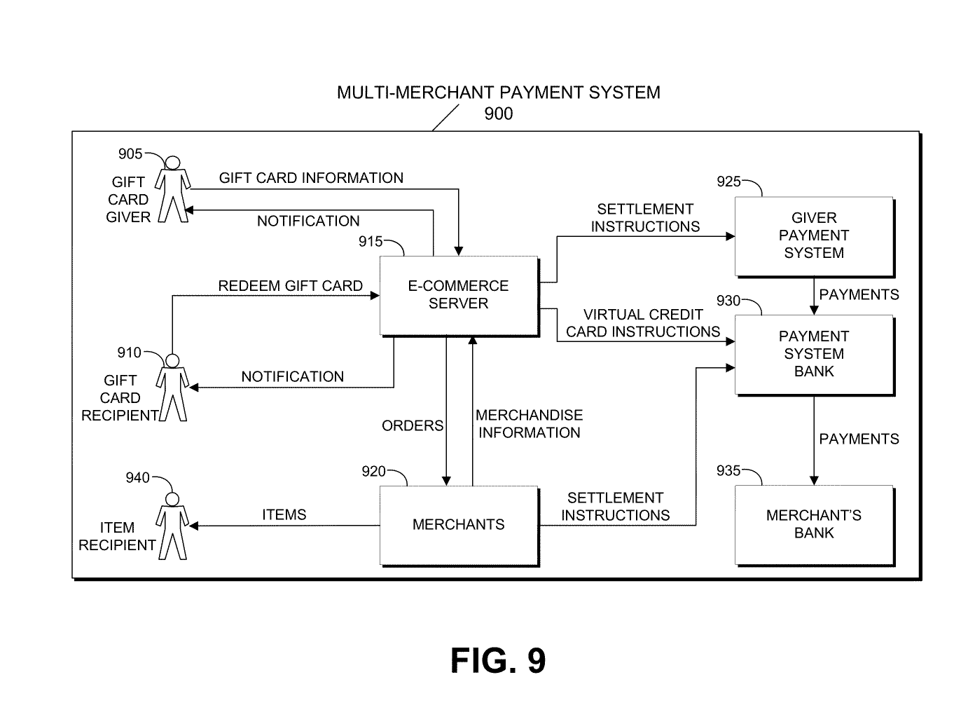

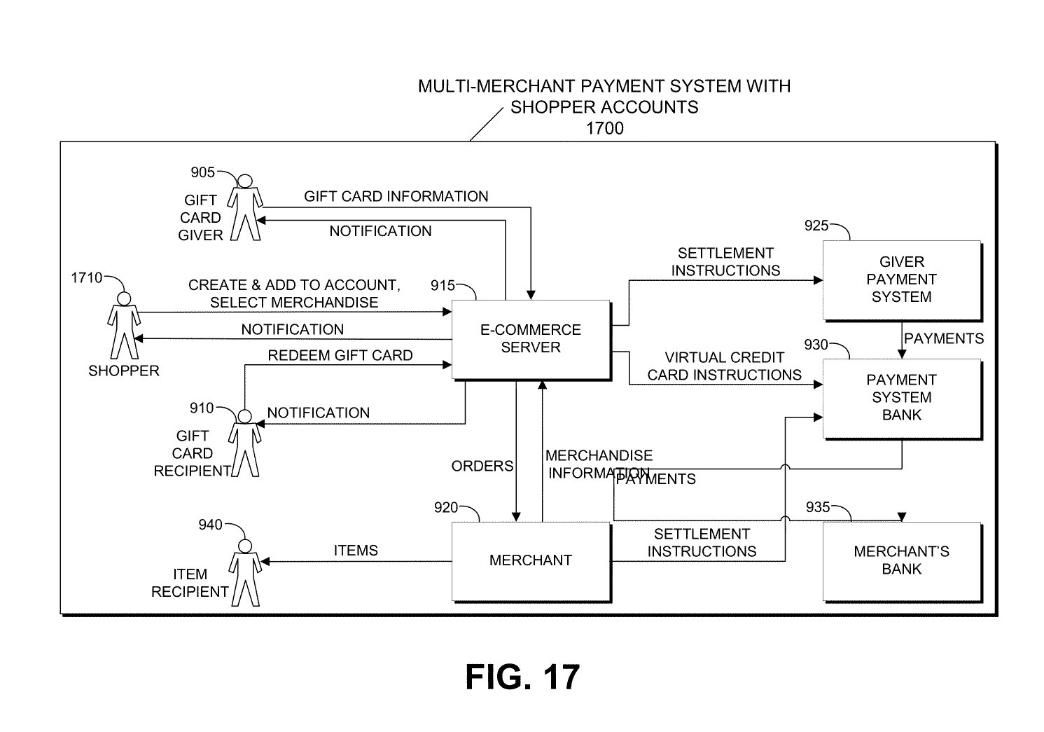

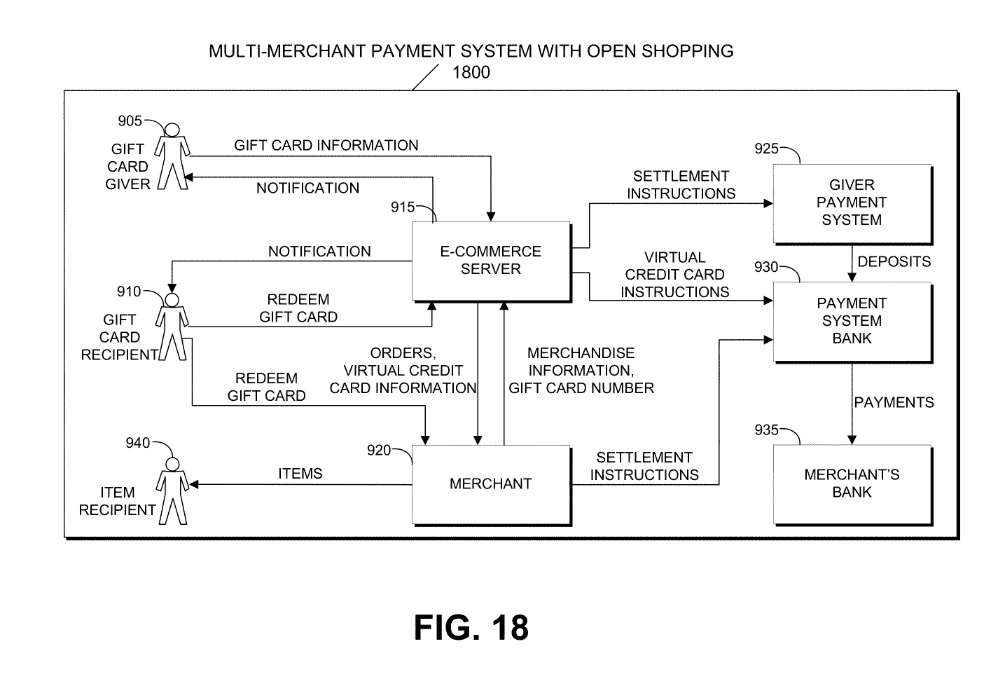

FIGS. 9-16 hereinbelow concern a multi-merchant payment system, which enables a gift card recipient to redeem a gift card by selecting one or more items at a multi-merchant website. FIGS. 17-18 concern additional embodiments of a multi-merchant payment system that uses gift cards.

Reference is now made to FIG. 9, which is a simplified block diagram of a multi-merchant payment system 900 that enables a gift card giver to purchase a gift card and for a gift card recipient to select items from a multi-merchant website, in accordance with an embodiment of the present invention. Shown in FIG. 9 is an e-commerce server 915 that interacts with at least one gift card giver 905, at least one gift card recipient 910, a plurality of merchants 920, at least one giver payment system 925, and at least one payment system bank 930.

E-commerce server 915 is a server computer system that enables merchants 920 to publish and showcase their catalogues of merchandise and services on a single integrated website, referred to as a multi-merchant website, which functions as a virtual shopping mall. E-commerce server 915 is represented as a single computer in FIG. 9 for the sake of clarity. However, e-commerce server 915 may be embodied in a single computer, or distributed as multiple computers communicating with one another.

Shoppers browsing the website are able to purchase one or more items from any merchant 920 that participates in the multi-merchant website by providing information about their items and enabling shoppers to purchase their items from the multi-merchant website. For purposes of clarity, henceforth the terms user and shopper both refer to a person that uses a Web browser such as Mozilla Firefox or Microsoft Internet Explorer together with a client computer or a mobile device that provides access to e-commerce server 915. Examples of mobile devices that provide access include the Apple iPhone provided by Apple Computer of Cupertino Calif., the Blackberry provided by Research in Motion of Waterloo, Ontario, and the Treo provided by Palm. Inc. of Sunnyvale, Calif. Generally, users of e-commerce server 915 register with the system by providing basic user information including inter alia name, physical address, e-mail address, means of payment information, shipping information, and personal information that may be used for authenticating the user.

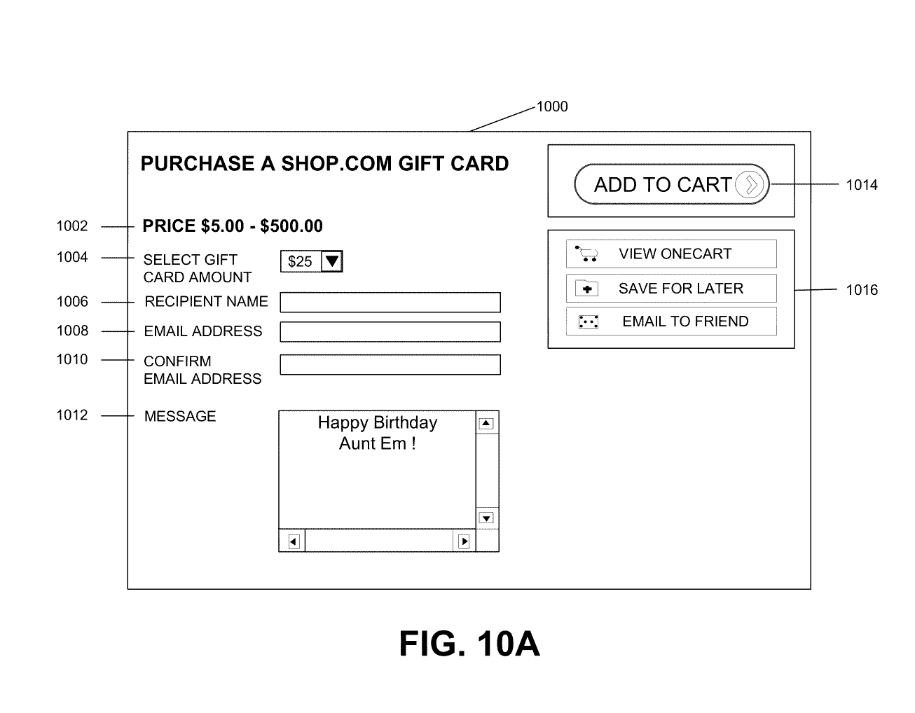

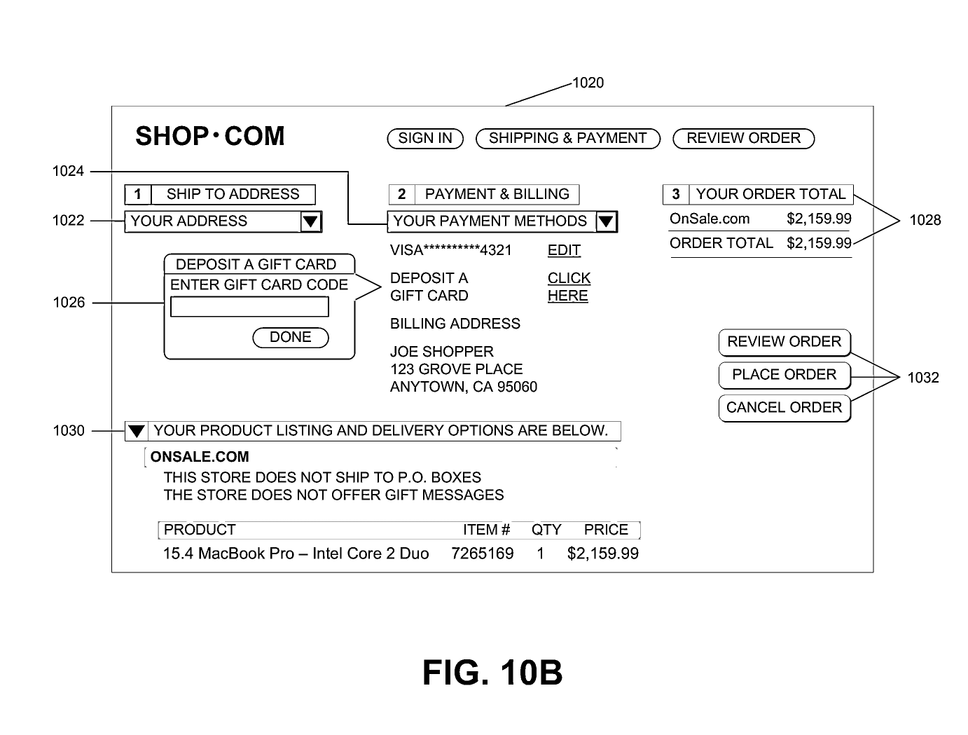

In accordance with an embodiment of the present invention, users may purchase gift cards for other users. A gift card giver 905 is a user that purchases a gift card from the multi-merchant website implemented by e-commerce server 915. Whereas, a gift card recipient 910 is a user that redeems a gift card from a multi-merchant website implemented by e-commerce server 915. At the time of purchase, gift card giver 905 supplies inter alia the name and contact information for a gift card recipient 910, the amount of the gift card, and means of payment information. Means of payment may include inter alia a credit card or points from a merchant reward points system such as a frequent flyer program, credit card reward points program or hotel reward points program. Gift card giver 905 may also apply an existing credit with multi-merchant payment system 900 when purchasing a gift card. An example user interface that enables gift card giver 905 to purchase a gift card is described with reference to FIG. 10A.

E-commerce server 915 uses the supplied means of payment information to request payment, from a giver payment system 925. Giver payment system 925 may be inter alia a credit card network in the case that gift card giver 905 supplied a credit card as his/her means of payment, or a reward points system in the case that gift card giver 905 supplied reward points program information. Typically, giver payment system 925 responds by depositing the requested amount into a “card funding account” in a payment system bank 930 designated by e-commerce server 915.

Upon receipt of payment in payment system bank 930, e-commerce server 915 establishes a “virtual credit card” (VCC) account for the gift card. The virtual credit card account acts like a standard credit card account in that it is established, funded, has a unique credit card number, and is guaranteed and operated by a bank. The initial amount credited to the virtual credit card acts as an initial limit against which purchases can be made and fees may be assessed. The act of establishing this initial amount is referred to as “loading” the virtual credit card account. The key differences between a virtual credit card and a standard credit card are that (1) the virtual credit card is created for the sole purpose of funding purchases linked to a specific gift card, (2) it is managed by e-commerce server 915 and not by gift card recipient 910, (3) it is terminated when the gift card has been used up, i.e. it is temporary in nature, and (4) no physical credit card is ever issued. Establishing and loading a virtual credit card are two of the virtual credit card instructions that e-commerce server 915 may issue to payment system bank 930. Other instructions include reloading, i.e. adding funds to a virtual credit card account, and closing a virtual credit card account.

The virtual credit card is secure; the actual credit card number is stored and managed by payment system bank 930 which generates a proxy credit card number that it provides to e-commerce server 915 for use by gift card recipient 910.

After creating the virtual credit card, e-commerce server 915 notifies gift card recipient 910 that he/she has been given a gift card and provides him/her with instructions on how to redeem the gift card. Typically, the instructions include the proxy credit card number which are referred to as a “gift card code.” To redeem a gift card, gift card recipient 910 visits the multi-merchant website provided by e-commerce server 915 and selects one or more items. Such an order is referred to as a “gift card order”. An example of a user interface that gift card recipient might use to browse for items of interest is described hereinabove with reference to FIG. 2B.

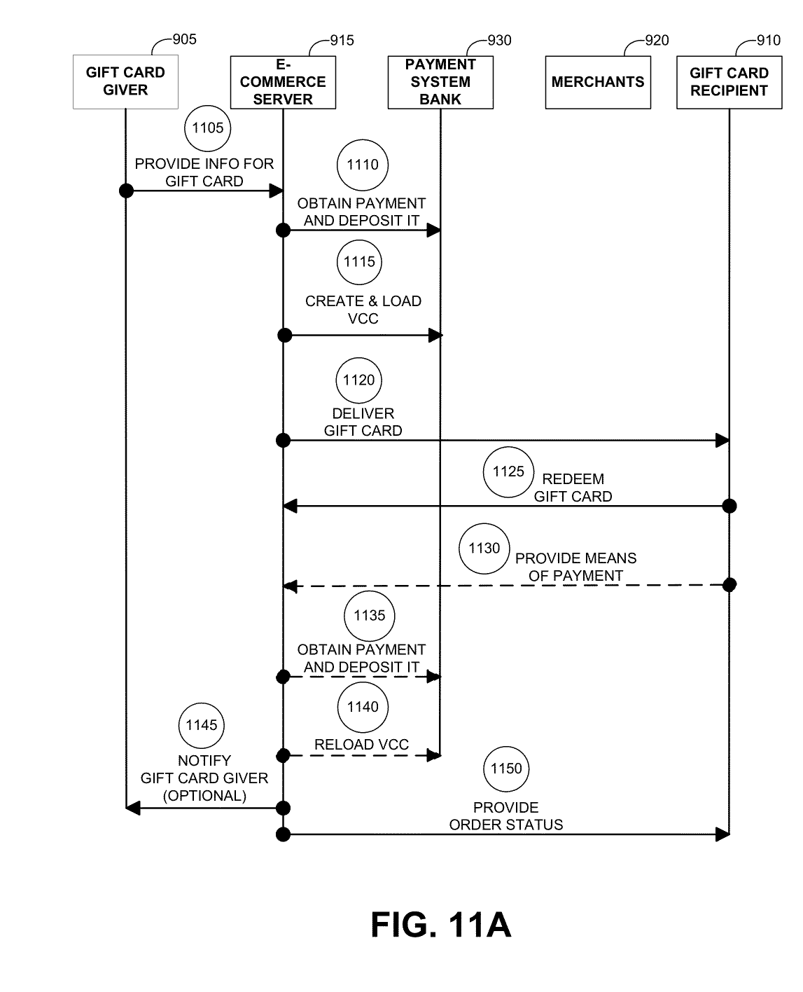

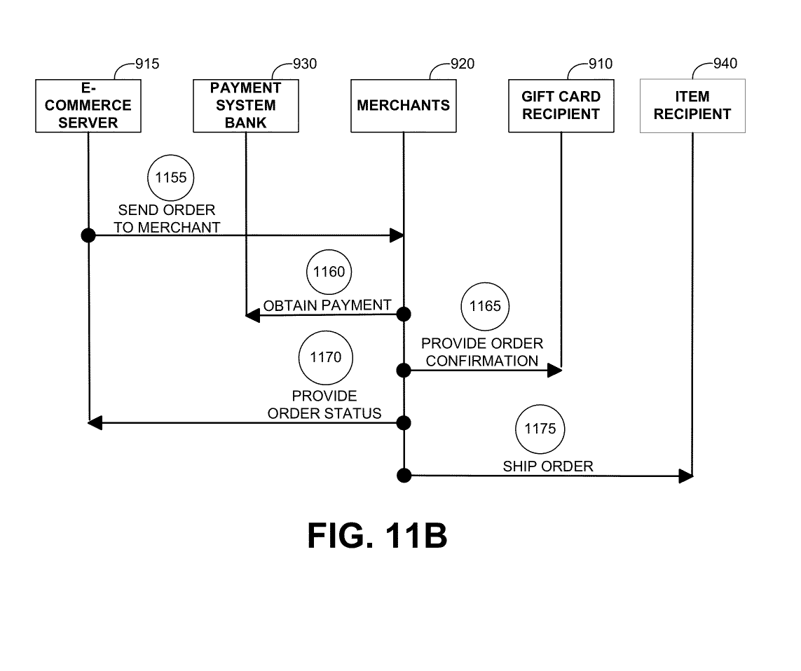

Gift card recipient 910 may “reload” the virtual credit card number at any time by supplying means of payment information, e.g. his/her credit card, and indicating how much money he/she wants to add to his/her virtual credit card account. Typically, gift card recipient 910 reloads his/her virtual credit card when he/she redeems his/her gift card by selecting items and the cost of the items exceed the remaining balance on the gift card. This case is described further with reference to FIG. 11A.

After selecting one or more items gift card recipient 910 finalizes his/her order by checking out. During the checkout process, gift card recipient 910 provides shipping and payment information and may review the order details. When providing payment information gift card recipient 910 indicates that he/she wishes to pay using a gift card and provides the gift card code. If the amount of the order is greater than the remaining balance then the gift card recipient is prompted to provide a credit card or other means of payment such as points from a rewards program. This supplemental means of payment is then used to reload the virtual credit card with the full amount of the order. An example user interface that enables gift card recipient 910 to provide shipping, payment and billing information is described with respect to FIG. 10B. When the checkout process is complete, e-commerce server 915 aggregates the selected items according to merchant and issues orders to each merchant 920 according to the aggregated selected items. E-commerce server 915 includes the virtual credit card account information with the order.

The order sent to each merchant 920 according to the aggregated selected items includes the virtual credit card account information. Merchant 920 uses the virtual credit card information to request authorization and settlement for the amount from payment system bank 930. Payment system bank 930 authorizes and settles the credit card transaction and payment is made to a designated account in merchant's bank 935. Each merchant 920 ships the selected items to one or more item recipients 940 as indicated in the order. Item recipient 940, also referred to as recipient 940, may be any individual, regardless of whether said individual is a registered user. Further item recipient 940 may be the same individual as gift card recipient 910 in the event that gift card recipient 910 purchases an item for hisself/herself.

Reference is now made to FIG. 10A which is an example user interface that enables a gift card giver to purchase a gift card, in accordance with an embodiment of the present invention. In this embodiment, the same method is used to purchase a gift card as to purchase an item of merchandise or service. Using the mufti-vendor website's search and browse tools, gift card giver 905 locates the gift card item and selects it. In response, user interface 1000 appears. As indicated in message 1002, a gift card with an amount between $5 and $500 can be purchased. It may be appreciated by one skilled in the art that the limitation on the gift card amount in user interface 200 to between $5 and $500 is arbitrary and that the present invention will enable the purchase of gift cards of any amount. Gift card giver 905 selects a denomination, i.e. a gift card amount, from a denominations menu 1004. Gift card giver 905 enters a gift card recipient name 1006, an email address 1008 for gift card recipient 910, confirmation of email address 1010 for gift card recipient 910, and an optional message 1012 that will be included along with the gift card and delivered to gift card recipient 910. When gift card giver 905 has finished entering the information on the left side of user interface 1000 he/she may use an “add to cart” control 1014 to add the gift card to his/her shopping cart. A set of controls 1016 enables gift card giver 905 to view his/her shopping cart, to save the information entered in user interface 1000 for later, or to email details of the gift card to a friend. Once the gift card has been added to the shopping cart using “add to cart” control 1014 the method for purchasing the gift card or “checking out” is identical to that used to purchase any other item from the multi-merchant website. An example of checking out is described below with reference to FIG. 10B.

Reference is now made to FIG. 10B which is an example user interface that enables a gift card recipient to redeem a gift card and to provide shipping, payment and billing information for his/her order, in accordance with an embodiment of the present invention. Typically, every web page provided by the multi-merchant website includes a navigation control that enables gift card recipient 910 to visit their shopping cart. Several of the capabilities provided by a shopping cart are shown in an example user interface 1020. Gift card recipient 910 may select a ship to address from a menu of ship to addresses 1022 that he/she has previously supplied. Alternatively, gift card recipient 910 may add a new ship to address. Gift card recipient 910 may select a payment method from a payment method menu 1024. If gift card recipient 910 selects “Gift Card” as the payment method then a gift card code prompt 1026 appears that enables gift card recipient 910 to enter a code of a gift card that they wish to use to pay for the items they have selected and which are in the shopping cart. If the amount of the order exceeds the balance of the gift card referenced by the gift card code then gift card recipient 910 may provide an additional payment method, e.g. a credit card or points from a rewards program, to pay the difference between the balance of the gift card and the amount of the order. The items in the shopping cart are shown in an order total box 1028 aggregated by merchant. A product listing section 1030 lists the items selected aggregated by merchant together with any special information for the merchant including inter alia shipping and delivery options. A set of controls 1032 enables gift card recipient 910 to review the order, place the order, or cancel the order.

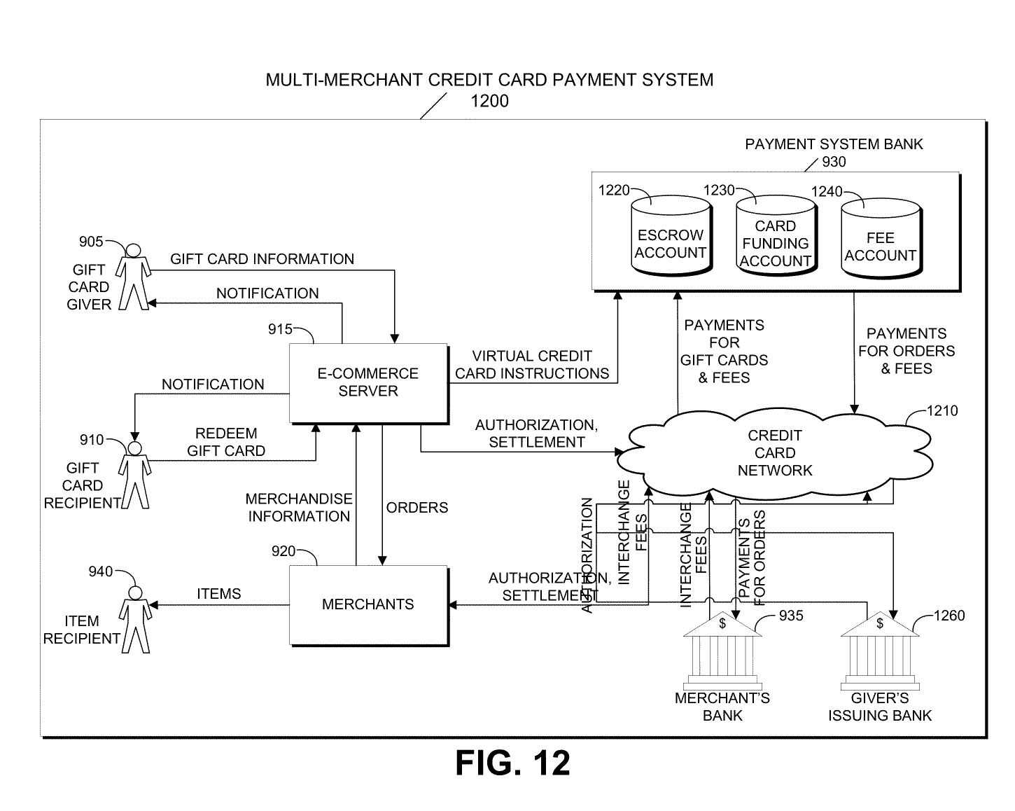

Reference is now made to FIG. 11A which is a simplified diagram of an overall method performed by a multi-merchant payment system, in accordance with an embodiment of the present invention. At step 1105 gift card giver 905 provides the necessary information to e-commerce server 915 to purchase a gift card including their means of payment information. In one embodiment, gift card giver 905 may, at their option, request that a notification be provided when the gift card has been redeemed. At step 1110 e-commerce server 915 uses the provided means of payment information to obtain payment and causes the payment to be deposited into a designated account in payment system bank 930. The method for obtaining payment varies for each means of payment. One method for obtaining payment for a credit card is described in greater detail with respect to FIG. 6A. In general, e-commerce server 915 interoperates with a plurality of giver payment systems 925. Typically, e-commerce server 915 provides instructions to giver payment system 925 to directly deposit the amount of the gift card minus any transaction fees that may be assessed into a designated account, referred to as a “card funding account”, in payment system bank 930. Upon successful completion of step 1110, the card funding account has been credited for the amount of the gift card purchase minus any transaction fees incurred in the transaction. An example of such a transaction fee is discussed hereinbelow with reference to FIG. 12.

At step 1110, if the attempt by e-commerce server 915 to obtain payment fails then gift card giver 905 is notified as such and given the opportunity to provide a different means of payment and the method restarts at step 1105.

At step 1115 e-commerce server 915 creates a virtual credit card account and loads it with the amount of the gift card. In this step, e-commerce server 915 also creates a “gift card record” which is a database record that includes information about the gift card such as the gift card code, gift card recipient name, balance, and expiration date. Then, at step 1120 e-commerce server 915 issues the gift card and delivers it to gift card recipient 910. Typically, the gift card is delivered by email. In one embodiment, gift card giver 905 can request that a physical, printed, gift card be delivered to gift card recipient. In this embodiment, e-commerce server 915 may issue instructions to an external organization that fulfills the printing, packaging and shipping of physical gift cards.

At step 1125 gift card recipient 910 redeems the gift card by visiting the multi-merchant website provided by e-commerce server 915 and selecting one or more items. In one embodiment, if gift card recipient 910 is not yet a registered user he/she is required to register and establish an account with e-commerce server 915. The cumulative price of all items selected by gift card recipient 910 including tax and shipping and handling charges is subtracted from the current balance stored in the gift card record. If the balance is positive or zero, i.e. the cumulative price is less than current balance, then the gift card record balance is updated. If the balance is negative then gift card recipient 910 is informed as such and they are requested to provide a means of payment to cover the difference. At step 1130, which appears as a broken line in the figure because it is a conditional step, gift card recipient 910 provides means of payment information to e-commerce server 915. At step 1135, also a conditional step, e-commerce server 915 uses the provided means of payment information to obtain payment and causes the payment to be deposited into the previously established card funding account for the gift card. At step 1140 e-commerce server 915 “reloads”, or adds to, the virtual credit card account the amount deposited into the card funding account. The card funding account is used to secure the virtual credit card account.

If gift card giver 905 requests notification upon redemption of the gift card, then at step 1145 such notification is made by e-commerce server 915. Such notification is typically in the form of an email message.

At step 1150, e-commerce server 915 provides notification of the status of the gift card order to gift card recipient, indicating the items that have been ordered.

Reference is now made to FIG. 11B, a continuation of FIG. 11A, which is a simplified diagram of the overall method performed by a multi-merchant payment system, in accordance with an embodiment of the present invention. At step 1155 e-commerce server 915 aggregates the selected items according to merchant and sends orders to each merchant 920 from which an item has been ordered. E-commerce server 915 sends the virtual credit card information with each order.

At step 1160 merchant 920 obtains payment from the card funding account in payment system bank 930. At step 1165 merchant 920 provides confirmation of the order to gift recipient 910. At step 1170 merchant 920 provides order status to e-commerce server 915. Finally, at step 1175, merchant 920 ships the items specified in the order to item recipient 940. Depending on the size, availability and location of the items more than one shipment may be required to fulfill the order.

Reference is now made to FIG. 12 which is a simplified block diagram of a multi-merchant credit card payment system 1200 that enables gift card givers to purchase gift cards using credit cards and for an e-commerce server to issue orders to merchants using credit cards, in accordance with an embodiment of the present invention. FIG. 12 illustrates one embodiment of multi-merchant payment system 900 described with reference to FIG. 9 in which payments are made using credit cards. Credit cards, including inter alia VISA, MasterCard, American Express and Discover, are an increasingly popular form of payment by shoppers. Credit card transactions are carried out across a credit card network 1210.

For purposes of clarity, credit card network 1210 includes a credit card processor for e-commerce server 915, a credit card processor for merchant 920 and a credit card network supported by each credit card processor. To further clarify, when a merchant receives an order from e-commerce server 915 and accepts a virtual credit card as payment for the order, the virtual credit card number, the amount, and a unique merchant identification code travel over their respective credit card processor's computer network. The credit card processor can either be a bank or a company that provides credit card processing services. From the processor's network the transaction goes to a credit card computer network. The electronic transaction travels across the network to the bank that actually issued the card, commonly referred to as the “issuing bank”. The issuing bank checks the account and verifies that there is adequate credit in the virtual credit card account to cover the purchase. The issuing bank then sends the merchant an authorization over the network. At this point, the sale is complete. Next, the transaction is “settled.” Settlement of a transaction occurs when the issuing bank for the virtual credit card debits the corresponding card funding account and makes the appropriate payment to the merchant's bank. The credit card network deducts a transaction fee from the payment to the merchant's bank which are allocated between the issuing bank and the credit card network itself.

In the embodiment illustrated in FIG. 12, gift card giver 905 uses a credit card as his/her means of payment for a gift card and provides the necessary credit card information including inter alia his/her name, the type of credit card, a credit card number and expiration date along with additional details about the order such as the destination(s).

E-commerce server 915 uses the credit card information to request authorization and settlement from credit card network 1210. Through credit card network 1210, a giver's issuing bank 1260 authorizes or rejects the request for credit. As previously discussed, giver's issuing bank 1260 is the bank that issued the credit card provided by gift card giver 905 as payment for the gift card. The transaction is subsequently settled and the funds are credited to a card funding account 1230 in payment system bank 930. The full amount of the gift card is credited to card funding account 1230. Typically, a transaction fee, commonly referred to as an “interchange fee,” is assessed and is withdrawn from a fee account 1240. The amount of the gift card appears on a periodic bill from giver's issuing bank 1260 to the credit cardholder, i.e. gift card giver 905.

As previously described, after payment for the gift card has been successfully processed, e-commerce server 915 issues instructions to payment system bank 930 to establish and load a virtual credit card account. Next, e-commerce server creates a gift card record for the gift card which includes a unique gift card code. The gift card code is a unique alphanumeric string. It should be noted that payment system bank 930 is the issuing bank for the virtual credit card. Thus, any interchange fees collected by credit card network 1210 for use of the virtual credit card will be paid to payment system bank 930. In one embodiment, payment system bank 930 shares interchange fees collected for use of virtual credit cards with the operator of multi-merchant credit card payment system 1200. The shared payment is paid into a specially designated fee account 1240.

The gift card code, which is subsequently provided to and used by gift card recipient 910 serves as an alias, or index, to the virtual credit card number. The gift card code is used by gift card recipient 910 to redeem items on the multi-merchant website. The gift card acts as a “closed-loop” payment system with respect to the gift card recipient 910 since it cannot be used outside multi-merchant payment system 1200 while the virtual credit card account allows it to also act an “open-loop” payment method with respect to merchants 920 since the virtual credit card is used to pay a plurality of merchants 920.

It may be appreciated that e-commerce server may work in conjunction with commercial services such as those provided by EFUNDS and METAVANTE to establish a virtual credit card account for a gift card.

As previously described, e-commerce server 915 issues an order to each merchant 920 from which gift card recipient 910 selected an item. As previously noted, the order includes the virtual credit card information for the gift card. As with any other credit card transaction, merchant 920 uses the virtual credit card information to request authorization and settlement from credit card network 1210. Using credit card network 1210, payment system bank 930 authorizes and settles the transaction, crediting the amount to a specified account in a merchant's bank 935. The amount credited is the amount of the gift card purchase minus an interchange fee. The credit card network pays the interchange fee to payment system bank 930 which is the issuing bank for the virtual credit card that was used to pay merchant 920. By mutual agreement, payment system bank 930 pays a share of interchange fees that it collects for use of virtual credits cards into fee account 1240.

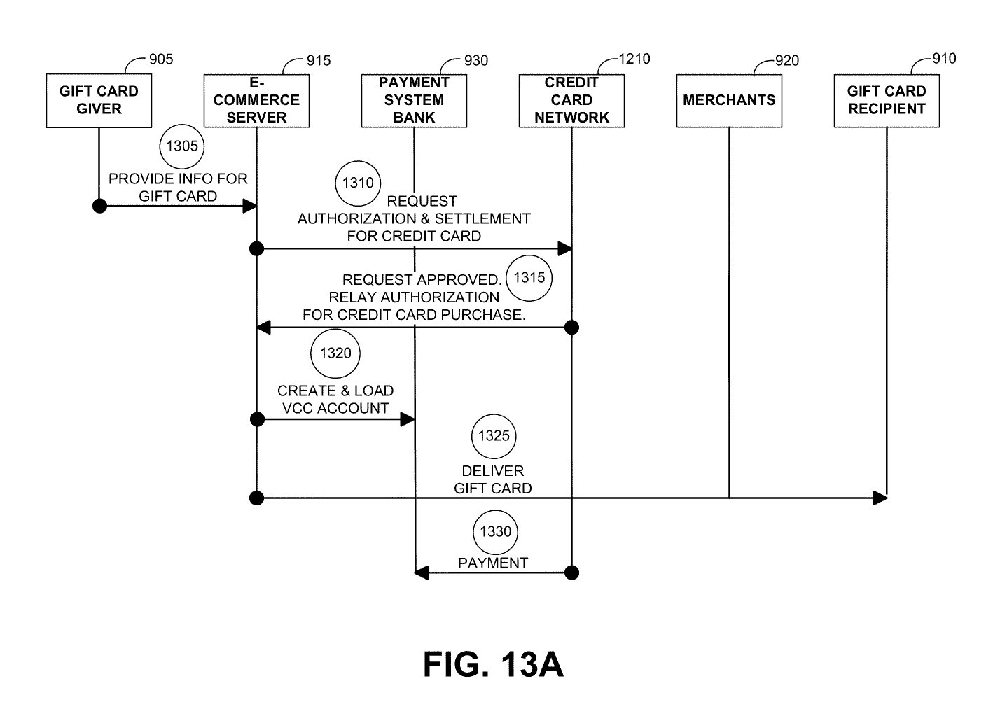

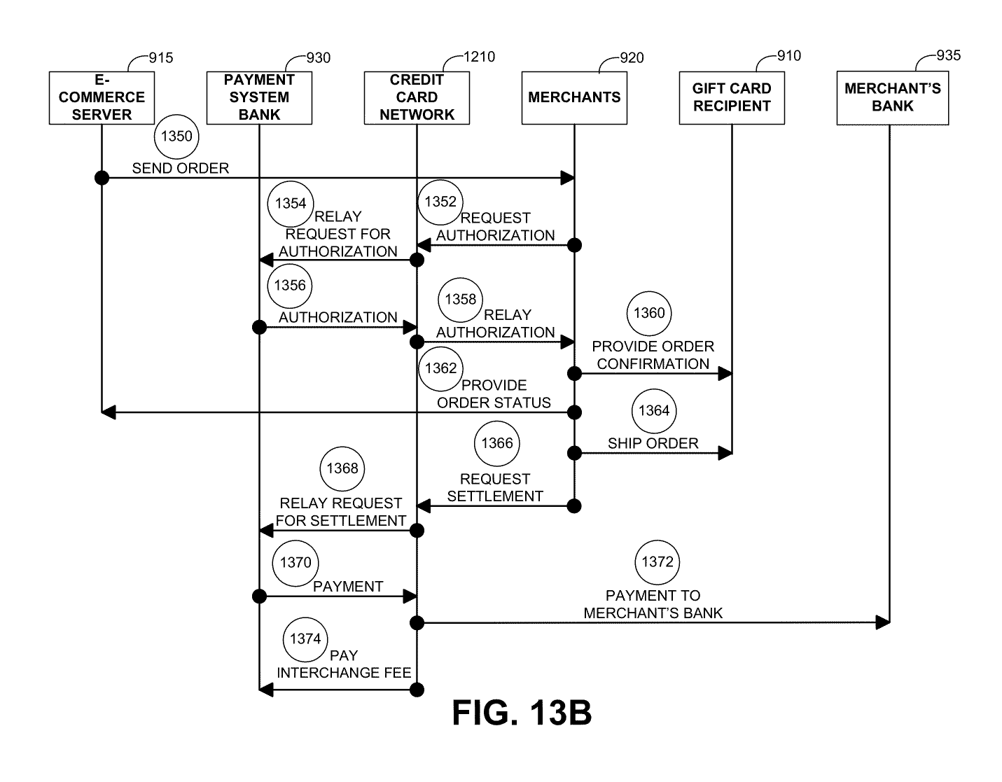

Now reference is made to FIG. 13A which is a simplified diagram of a method for issuing a gift card when the gift card is purchased using a credit card, in accordance with an embodiment of the present invention. During the process of purchasing a gift card, at step 1305, gift card giver 905 selects credit card as the means of payment and provides the necessary credit card information including inter alia their name, type of credit card, credit card number and expiration date.

At step 1310, e-commerce server 915 requests authorization and settlement for the purchase from credit card network 1210 by providing the details about the credit card and the amount of purchase. The credit card information is sent to credit card network 1210 for authorization and settlement. After authorization is received from giver's issuing bank 1260, at step 1315 credit card network 510 relays the authorization to e-commerce server 915.

Upon successful authorization, at step 1320 e-commerce server 915 creates a virtual credit card account at payment system bank 930, loads it with the gift card amount and also creates a gift card record. Then, at step 1325 e-commerce server 915 delivers the gift card to gift card recipient 910.

At step 1330, the transaction is settled and giver's issuing bank 1260 makes payment which is credited to card funding account 1230 and the transaction is complete.

Now reference is made to FIG. 13B which is a simplified diagram of a method for redeeming a gift card using a virtual credit card account established by a multi-merchant e-commerce system, in accordance with an embodiment of the present invention. As part of the gift card redemption process, e-commerce server 915 aggregates the items selected by gift card recipient 910 according to merchant 920 and at step 1350 sends an order to each merchant 920 from which an item has been ordered. The present example describes the payment processing relative to a single order from a single merchant 920. E-commerce server 915 includes with the order information about the virtual credit card to be used to pay merchant 920 for the order. At step 1352, merchant 920 uses credit card network 1210 to request authorization for the credit card purchase. At step 1354 credit card network 1210 relays the request for authorization to payment system bank 930 which is the issuing bank for the virtual credit card. At step 1356 payment system bank 930 authorizes the purchase by sending an authorization message to credit card network 1210. Then, at step 1358 credit card network 1210 relays the authorization to merchant 920.

After receiving authorization, at step 1360 merchant 920 provides a confirmation to gift card recipient 910 that the order has been successfully received and authorized. Such notification may also contain shipping details or other information concerning the order. At step 1362 merchant 920 provides an order status message to e-commerce server 915 indicating that the order has been authorized. Such order status message may also contain shipping details or other information concerning the order.

At step 1364 merchant 920 ships the order containing the selected items to the designated recipient. It may be appreciated that the shipment may occur at any time after the actual order. For example, if one or more of the items selected are not in stock there may be a shipping delay. Or, there may be a processing delay of one or several days while gathering, and packaging the items. In general, the precise details of the shipping process are outside the scope of the present invention.

At step 1366 merchant 920 requests settlement for the amount of the order from credit card network 1210. At step 1368 credit card network 1210 relays the request for settlement to payment system bank 930. At step 1370 payment system bank 930 settles the transaction by making the requested payment using credit card network 1210. At step 1372 credit card network makes payment to a designated account in merchant's bank 935. Credit card network 1210 retains the interchange fee which, at step 1374, it pays to payment system bank 930. In one embodiment a percentage of the interchange fee is paid by payment system bank into fee account 1240.

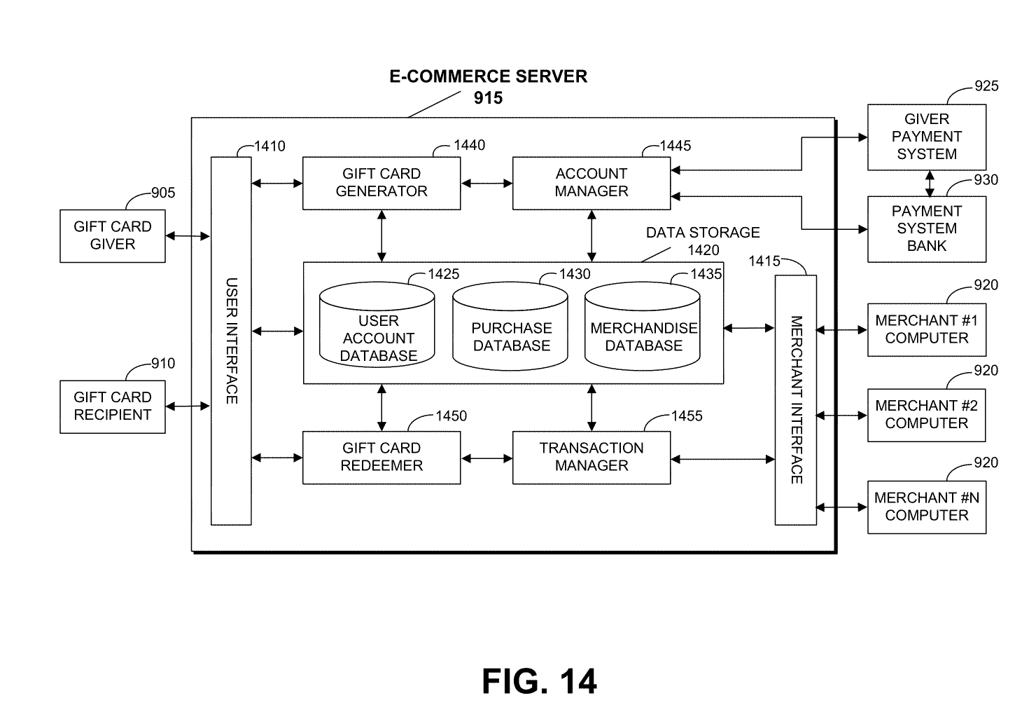

Reference is now made to FIG. 14, which is a simplified block diagram of an e-commerce system that supports a multi-merchant payment system, in accordance with an embodiment of the present invention. Users interact with the website via a user interface 1410, merchants interact with the website via a merchant interface 1415, and e-commerce server 915 interacts with a payment system bank 930 and giver payment system 925 via an account manager 1445.

A data storage 1420 stores a user account database 1425, a purchase database 1430 and a merchandise database 1435. It may be appreciated by one skilled in the art that data storage 1420 refers to a logical storage system typically implemented using a relational database manager and does not imply or suggest a particular physical or hardware implementation. Merchandise database 1435 stores a record for each item of merchandise or service published by any merchant 920. Each record includes (i) a stock keeping unit (SKU) for the item, (ii) a description of the item, (iii) a description of product options for the item, (iv) a price of the item with and without the product options, (v) shipping information for the item including shipping cost, and (vi) the merchant who provides the item. The SKU functions as a unique identifier for the item. The description generally includes one or more images of the item and a text description.

User account database 1425 stores a record for each user, also referred to as a “shopper.” Each record includes (i) a user name, (ii) billing and shipping address for the user, and (iii) means of payment information.

User interface 1410 enables shoppers to browse and search merchandise database 1435 for desired items of merchandise and services, and purchase desired items on-line. User interface 1410 is typically a web interface composed of HTML web pages. Said HTML web pages may be static web pages stored as HTML files or may be generated dynamically in response to shopper requests. Merchant interface 1415 enables merchants to add new items to merchandise database 1435, remove old items of merchandise, and modify existing items.

A gift card generator 1440 enables gift card giver 905 to purchase a gift card via user interface 1410. Gift card generator 1440 displays a data entry form that enables gift card giver 905 to supply inter alia the name and contact information for a gift card recipient 910, the amount of the gift card, and a credit card or other means of payment information. Gift card generator 1440 creates a gift card record in a purchase database 1430 and stores the data supplied by gift card giver 905 in the new gift card record. Purchase database 1430 stores a gift card record for each gift card. Each such record includes (i) a unique identifier for the gift card, referred to as a gift card code, (ii) the name and contact information of the giver of the gift card, (iii) the date of purchase, (iv) means of payment information, (v) the initial amount of the gift card, (vi) the remaining balance of the gift card, (vii) the name and contact information of the gift card recipient, (viiii) an optional message from the gift card giver to the gift card recipient, and (ix) virtual credit card information for the gift card. The gift card code functions as a unique identifier for the gift card. Gift card generator 1440 may request that gift card giver 905 sign in before beginning or concluding the gift card purchase. Gift card generator 1440 uses information stored in user account database 1425 as part of the sign-in process. If gift card giver 905 is not a registered user, then gift card generator 1440 enables gift card giver 905 to register with e-commerce server 915. In this case, gift card generator 1440 creates a new record in user account database 1425 for gift card giver 905.

Account manager 1445 processes the means of payment information provided by gift card giver 905. Account manager 1445 makes payments to, or uses the means of payment information to cause payments to be made to, the card funding account 1230. Account manager 1445 further manages the payment and receipt of transaction fees. Account manager 1445 tracks payments into and out of the card funding account and any other accounts in payment system bank 930. For each gift card, account manager 1445 manages a virtual credit card that is used to make payments to merchants by performing operations including creating, loading, reloading, and closing the virtual credit card. Account manager 1445 stores the virtual credit card information with the gift card record in purchase database 1430.

After gift giver 905 purchases a gift card, a gift card redeemer 1450 notifies gift card recipient 910 that they have been given a gift card and provides him/her with the previously described gift card code as well as instructions on how to redeem the gift card. Gift card redeemer 1450 enables gift card recipient 910 to redeem his gift card. Gift card recipient 910 presents his/her gift identifier to gift card redeemer 1450 via user interface 1410. Gift card redeemer 1450 may request that gift card recipient 910 sign in before beginning or concluding the gift card redemption process. It uses user information stored in user account database 1425 as part of the sign-in process. If gift card recipient 910 is not a registered user, then gift card redeemer 1450 enables gift card recipient 910 to register with e-commerce server 915. In this case, gift card redeemer 1450 creates a new record in user account database 1425 for gift card recipient 910.

In one embodiment, user interface 1410 displays a counter with a running unspent balance, or alternatively a running total of current cost.

After gift card recipient 910 makes his/her selection of items, a transaction manager 1455 enables gift card recipient 910 to check out, i.e. provide information necessary to complete the order, and review the order details. If the order total, which is the aggregate price of all items selected including tax, shipping and handling charges, is equal to the remaining balance of the gift card, the gift card is marked as “redeemed” in purchase database 1430. In one embodiment, if the aggregate price is greater than the gift card amount, gift card recipient 910 is requested by transaction manager 1455 to provide a means of payment to pay the difference between the total amount due for the items purchased and the balance of the gift card. The virtual credit card account is then reloaded with the full amount of the purchase and the gift card is marked as redeemed in purchase database 1430. Alternatively, gift card recipient 910 may delete one or more items he/she selected in order to reduce the purchase price to less than the remaining balance of the gift card.

After gift card recipient 910 provides additional details, reviews and finalizes his/her order, transaction manager 1455 aggregates the selected items according to each merchant 920. Transaction manager 1455 then issues orders to each merchant 920 according to the aggregated selected items. Each order includes the virtual credit card information for the gift card being used as a means of payment that enables a merchant 920 to obtain payment for the selected items. As previously mentioned, from the perspective of merchants 920, a virtual credit card is the same as a standard credit card, i.e. merchants 920 process a virtual credit card in the same way that they process a standard credit card. Each merchant 920 ships the selected items indicated in their order to the designated address(es).

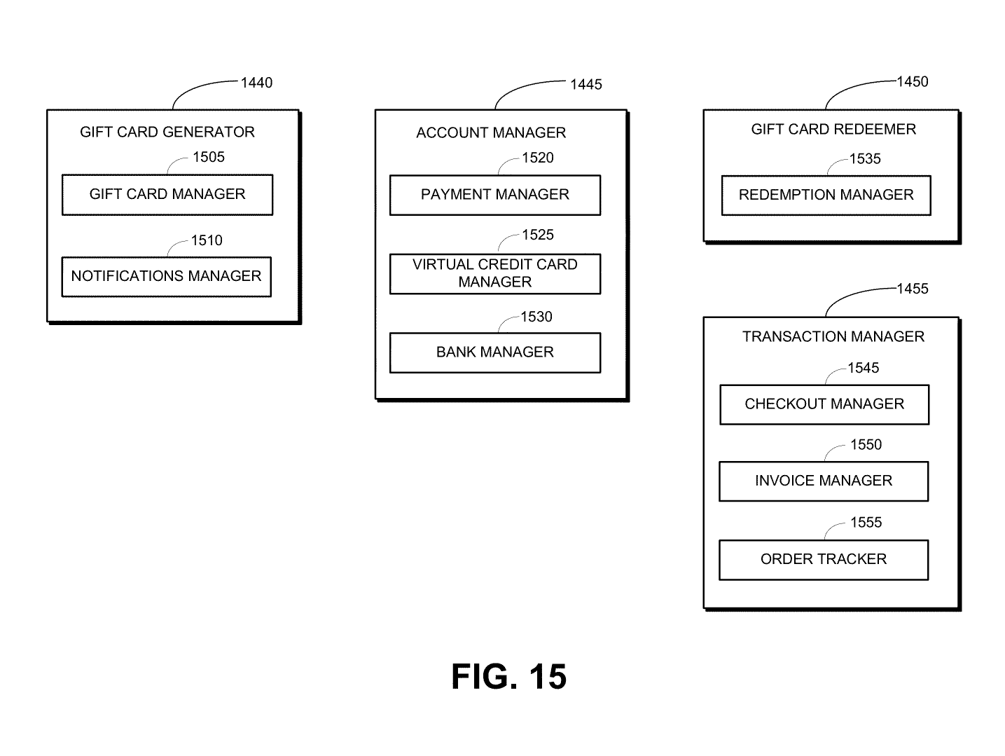

Reference is now made to FIG. 15, which is a simplified block diagram of various components of the e-commerce server illustrated in FIG. 14, in accordance with an embodiment of the present invention. Shown in FIG. 15 are sub-components of gift card generator 1440, account manager 1445, gift card redeemer 1450, and transaction manager 1455.

Gift card generator 1440 includes a gift card manager 1505 that manages presentation of the gift card choices, including associated messages, an optional background, and optional multimedia including music, images and video. Gift card generator 1440 uses transaction manager 1555 to enable the gift giver to specify one or more recipients, the timing and method of delivery for the items included in the order, and personalized greetings and messages. Additionally, gift card generator 1440 uses an invoice manager 1555 to manage financial details of the gift card's purchase. Finally, gift card generator 1440 includes a notifications manager 1510 that notifies inter alia gift card recipient 910 that a gift card has been sent to him/her, gift card giver 905 that the gift has been redeemed or rejected, gift card giver 905 that gift card recipient 910 has not yet redeemed his/her gift after a certain period of time, and gift card recipient 910 if any of the gift choices are not available.

Account manager 1445 includes a payment manager 1520 that manages the process of obtaining payment from giver payment system 925. Payment manager 1520 is capable of interacting with credit card network 1210 in the case that gift card giver 905 pays with a credit card. Payment manager 1520 is further capable of redeeming points from reward points systems. It may be appreciated that payment manager 1520 may operate with a wide variety of electronic payment systems. Account manager 1445 further includes a virtual credit card manager 1525 that creates a virtual credit card for each gift card that is purchased. Virtual credit card manager 1525 stores information about the gift card order in purchase database 1430. Virtual credit card manager 1525 is capable of loading, reloading and closing a virtual credit card account. Account manager 1445 further includes a bank manager 1530 that manages interactions with payment system bank 930. Bank manager 1530 verifies the balances in each of the accounts used by e-commerce server 915 including the card funding account and fee account. Bank manager 1530 ensures that all necessary fees are paid to and collected from credit card network 1210.

Gift card redeemer 1450 includes a redemption manager 1535 that manages presentation of any gift card related information presented to gift card recipient 910. Such related information may include a running counter that displays the amount of the gift card that has been spent and the amount remaining. Redemption manager 1535 also provides tools that enable gift card recipient 910 to inter alia return a redeemed item, cancel a redeemed item, and request re-issuance of a gift card.

Transaction manager 1455 includes a checkout manager 1545 for managing the checkout process including obtaining delivery information, payment and billing information and for obtaining payment information from gift card recipient 910 in case the order total exceeds the gift card balance. Transaction manager 1455 further includes an invoice manager 1550 for invoicing gift card recipient 910 based upon his/her selected items, and an order tracker 1555 for tracking the items ordered by the gift recipient 910.

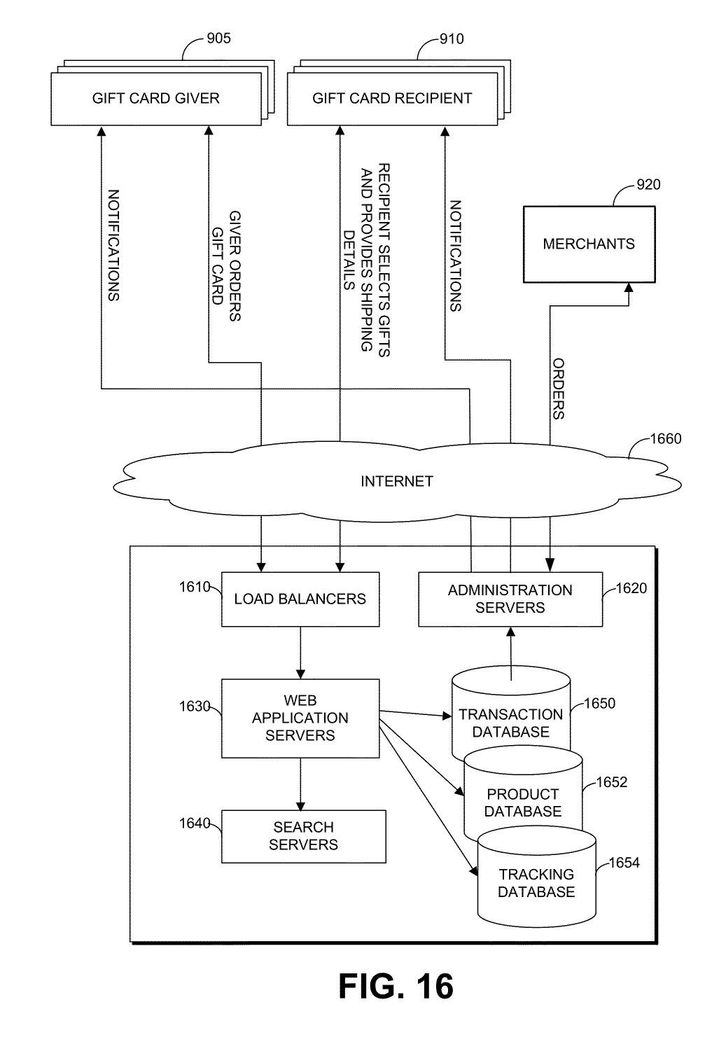

It will be appreciated by those skilled in the art that the systems and methods of the present invention may be implemented within a variety of server-client network architectures. In this regard, reference is now made to FIG. 16, which is a simplified block diagram of an example client-server architecture for implementing a multi-merchant payment system, in accordance with an embodiment of the present invention. On the server side, the architecture in FIG. 16 includes one or more Web application servers 1630 managed by load balancers 1610, administration servers 1620, search servers 1640, and three databases. The databases include a transaction database 1650 for recording purchase and payment information, including the data from purchase database 1430 shown in FIG. 14, a product database 1652 for storing product catalogue information, including the data from merchandise database 1435, and a tracking database 1654 for tracking shopper orders and shopper information including user account database 1425. Web application servers 1630 manage transaction database 1650, product database 1652, tracking database 1654, and search servers 1640. It may be appreciated by one skilled in the art that Web application servers 1630 also act as Web servers in that they accept HTTP requests from Web browsers and serve them HTTP responses along with optional data contents, which usually are web pages such as HTML documents and linked objects (images, etc.). All of these server components are subsumed in e-commerce server computer 915.

On the client side, the architecture in FIG. 16 includes merchants 920, one or more gift card givers 905 using client computers, and one or more gift card recipients 910 using client computers. Merchants 920 have two-way connections with administration servers 1620. Administration servers 1620 send notifications to client computers. Thus, the client computers of gift card givers 905 and gift card recipients 910 have one-way connections with administration servers 1620. The client computers of gift card givers 905 and gift card recipients 910 have two-way connections with load balancers 1610.

Client-server communication is performed over the Internet 1660.

Reference is now made to FIG. 17, which is simplified block diagram that, relative to FIG. 9, adds the ability for a shopper to create and add funds to a shopper account that they can use to make selections, in accordance with an embodiment of the present invention. A multi-merchant payment system with shopper accounts 1700 is an embodiment that enables a shopper using the multi-merchant website provided by e-commerce server 915 to create a “shopper account”, add funds to a shopper account, make payments using a shopper account, and close a shopper account. A shopper account behaves identically to a gift card with the exceptions that shopper 1710 (1) creates and opens the account themselves, and (2) makes an initial deposit or payment into their shopper account.

To enable the creation and use of shopper accounts, ecommerce server 915 is enhanced to provide the following additional capabilities. Gift card generator 1440, described with reference to FIG. 14 enables shopper 1710 to create and fund a shopper account via user interface 1410. Gift card generator 1440 displays a data entry form that enables shopper 1710 to supply inter alia the amount that they wish to add to their shopper account and a credit card or other means of payment information. Gift card generator 1440 creates a new shopper record in purchase database 1430 and stores the data supplied by shopper 1710 in the new record. Each such record includes (i) a unique identifier for the shopper account, referred to as a “shopper identifier”, (ii) the name of the shopper, (iii) the date of purchase, (iv) means of payment information, (v) the amount to be added to the shopper account, (vi) the remaining balance of the shopper account, and (ix) virtual credit card information for the shopper account. The shopper identifier functions as a unique identifier for the shopper account. Gift card generator 1440 may request that shopper 1710 sign in before adding funds to his/her shopper account. Gift card generator 1440 uses shopper information stored in user account database 1425 as part of the sign-in process. If shopper 1710 is not a registered user, then gift card generator 1440 enables shopper 1710 to register with e-commerce server 915. In this case, gift card generator 1440 creates a new record in user account database 1425 for shopper 1710.

As with a gift card, once shopper 1710 makes an initial payment, e-commerce server 915 creates and loads a virtual credit card account. E-commerce server 915 notifies shopper 1710 when the shopper account has been successfully created and provides shopper 1710 with a unique shopper identifier. Shopper 1710 selects items from the e-commerce website provided by e-commerce server 915 and provides his/her shopper identifier as means of payment for said items.

Shopper 1710 may add funds to their shopper account at any time, in which case e-commerce server reloads the corresponding virtual credit card account using the means of payment provided by shopper 1710. Additionally, shopper 1710 may use multi-merchant payment system with shopper accounts 1700 to convert points from a reward points program to currency and add the currency to their shopper account. Subsequently shopper 1710 may shop for merchandise and services using the multi-merchant website provided by e-commerce server 915 and pay for said merchandise and services using their funded shopper account.

Reference is now made to FIG. 18, which is a simplified block diagram that, relative to FIG. 9, adds the ability for a gift card recipient to redeem his/her gift card at e-commerce websites provided by a plurality of merchants, in accordance with an embodiment of the present invention. A multi-merchant payment system with open shopping 1800 is an alternative embodiment that adds an “open shopping” service which enables gift card recipient 910 to redeem his/her gift card at the e-commerce websites provided by merchants 920 in addition to or in place of the multi-merchant website provided by e-commerce server 915. Merchants 920 that participate in the open shopping service allow gift card recipient 910 to pay for merchandise and services at their respective e-commerce websites using gift cards.

During the payment process, merchant 920 enables gift card recipient 910 to provide a gift card code as a means of payment. Merchant 920 then transmits the gift card code, the gift card recipient's name and potentially other information to e-commerce server 915 for authorization. E-commerce server 915 authenticates the gift card code provided by merchant 920 and in turn provides merchant 920 with the virtual credit card information that corresponds to the gift card, thus enabling merchant 920 to obtain payment from gift card recipient 910.

A further alternative embodiment of the present invention combines the enhanced capabilities described with reference to FIGS. 17 and 18. Specifically, this embodiment adds the ability for shopper 1710 to establish and use a shopping account and for shopper 1710 to use the account to select items from the e-commerce websites provided by merchants 920 that participate in the open shopping system described with reference to FIG. 18. Rather than provide a gift card code as means of payment to the e-commerce website provided by merchant 920, shopper 1710 provides his/her shopper identifier.

In reading the above description, persons skilled in the art will realize that there are many apparent variations that can be applied to the methods and systems described.

What is claimed is:

1. A computer-processor based method of payment for multi-vendor gift cards, comprising:
maintaining, by an e-commerce server, a database comprising records for merchandise or services for sale by a plurality of merchants;
enabling, by the e-commerce server, a gift card giver to interactively purchase a gift card for a specified amount of money for a gift card recipient and to provide method of payment information;
electronically obtaining, by the e-commerce server, the specified amount of money using said method of payment information and transferring the specified amount of money into a card funding account that is used to pay for purchases by the gift card recipient;
enabling, by the e-commerce server, the gift card recipient to interactively select an item from the database; and
paying, by the e-commerce server, the merchant that corresponds to the selected item for the selected item from the card funding account.

2. The method of claim 1 further comprising issuing an order, by the e-commerce server, to the corresponding merchant for the selected item.

3. The method of claim 1 wherein said method of payment comprises converting points from a reward points system to currency.

4. The method of claim 1 further comprising enabling the gift card recipient to add additional funds to the card funding account.

5. A network computing device, comprising:
a storage device useable to store a database comprising records for merchandise and services for sale by a plurality of merchants;
a processor that is programmed to enable access to the storage device and to perform actions, comprising:
enabling a gift card giver to interactively purchase a gift card for a specified amount of money for a gift card recipient and to provide method of payment information;
obtaining the specified amount of money using said method of payment information and transferring the specified amount of money into a card funding account that is used to pay for purchases by the gift card recipient;
enabling the gift card recipient to interactively select an item from the database; and
paying the merchant that corresponds to the selected item for the selected item from the card funding account.

6. The network computing device of claim 5 wherein the processor is programmed to perform actions further comprising issuing an order to the corresponding merchant for the selected item and wherein said paying the merchant comprises providing to the merchant means of payment information that enables the merchant to obtain payment for the order from the card funding account.

7. The network computing device of claim 5 wherein said method of payment consists of converting points from a reward points from a reward system to currency.

8. The network computing device of claim 5 wherein the processor is programmed to perform actions further comprising enabling the gift card recipient to add additional funds to the card funding account.

9. A computer-processor based method of payment for multi-vendor gift cards, comprising:
maintaining, by an e-commerce server, a database comprising records for merchandise and services for sale by a plurality of merchants;
enabling, by the e-commerce server, a gift card giver to interactively purchase a gift card for a specified amount of money for a gift card recipient and to provide method of payment information for the purchase;
obtaining, by the e-commerce server, the specified amount of money using said method of payment;
issuing orders, by the e-commerce server, to (i) create a virtual credit card account, said account corresponding to said gift card, and (ii) load the specified amount of money into the virtual credit card account;
receiving, by the e-commerce server, a selection of an item from the database, said selection made by the gift card recipient; and
providing information about the virtual credit card, by the e-commerce server, to a merchant that corresponds to the selected item in payment for the selected item.

10. The method of claim 9 further comprising issuing an order, by the e-commerce server, to the merchant that corresponds to the selected item for the selected item.

11. The method of claim 9 further comprising enabling the gift card recipient to electronically add additional funds to the virtual credit card account.

12. A computer-processor based method of electronic payment, comprising:
maintaining, by the payment server, a database comprising records for shopper accounts;
enabling, by a payment server, a shopper to interactively create a shopper account and to interactively deposit a specified amount of money in the shopper account;
providing, by the payment server, the shopper with a unique shopper identifier that corresponds to the shopper account, said unique shopper identifier serving as a means of payment for a shopper to make purchases at a plurality of merchants' e-commerce websites; and
paying a merchant from the shopper account, by the e-commerce server, for a purchase at the merchant's e-commerce website by the shopper, wherein said shopper used said unique shopper identifier as a means of payment.

13. The method of claim 12 further comprising providing by the payment server to the merchant's e-commerce website additional shopper account information in order to complete the purchase made at the merchant's e-commerce website.

14. The method of claim 12 further comprising:
creating, by the e-commerce server, a virtual credit card account for said shopper account; and
loading the virtual credit card account with the specified amount of money;
wherein said paying from the shopper account comprises providing information about said virtual credit card account to the merchant in response to receiving the unique shopper identifier therefrom.

15. The method of claim 12 further comprising enabling, by the payment server, the shopper to interactively deposit additional money into the shopper account.

16. A network computing device, comprising:
a storage device useable to store a database comprising records for shopper accounts;
a memory in communication with the storage device for storing program instructions; and
a processor, in communication with the memory that executes the instructions causing the network computing device:
to enable a shopper to interactively create a shopper account and to interactively deposit a specified amount of money in the shopper account;
to provide the shopper with a unique shopper identifier that corresponds to the shopper account, said unique shopper identifier serving as a means of payment for the shopper to make purchases at a plurality of merchants' e-commerce websites; and
to pay a merchant from the shopper account for a purchase at the merchant's e-commerce website by the shopper, wherein said shopper provided said unique shopper identifier as a means of payment.

17. The network computing device of claim 16 wherein executing the instructions further causes the network device to provide to the merchant's e-commerce website additional shopper account information in order to complete the purchase made at the merchant's e-commerce website.

18. The network computing device of claim 16 wherein executing the instructions further causes the network device:
to create a virtual credit card account for said shopper account; and
to load the virtual credit card account with the specified amount of money;
wherein said paying from the shopper account comprises providing information about said virtual credit card account to the merchant in response to receiving the unique shopper identifier therefrom.

19. The network computing device of claim 16 wherein executing the instructions further causes the network device to the shopper to interactively deposit additional money into the shopper account.
